(19) United States
(12) Patent Application Publication
(10) Pub. No.: US 2018/0126285 A1
(43) Pub. Date: May 10, 2018

(54) ENGINE, SYSTEM AND METHOD FOR PROVIDING FANTASY SPORTS PLAY

(71) Applicant: ZCO ACQUISITIONS, INC., Minneapolis, MN (US)

(72) Inventor: Daniel G. KEHOE, Atlanta, GA (US)

(21) Appl. No.: 15/569,760

(22) PCT Filed: Nov. 18, 2015
(86) PCT No.: PCT/US15/61421

§ 371 Date: Oct. 26, 2017

Related U.S. Application Data
(60) Provisional application No. 62/081,370, filed on Nov. 18, 2014.

(51) Int. Cl. A63F 13/825; A63F 13/30

(52) U.S. Cl. CPC A63F 13/825; A63F 13/30

(57) ABSTRACT

The present invention provides a gaming architecture apparatus, system and method suitable for providing fantasy sports play. The apparatus, system and method may provide for accessing, from at least one network-accessible remote memory store, a plurality of outcome data indicative of player performance of real world sports play correspondent to the fantasy sports play, wherein the plurality of outcome data accessed at least partially comprises historical player performance data. Further provided may be a transforming of the plurality of outcome data to fantasy sports play data agnostically to an active or inactive status of the real world sports play, and a determination of an outcome of the fantasy sports play at least partially in accordance with the fantasy sports play data.

### PRIORITY

This application claims the priority benefit of U.S. Provisional Application No. 62/081,370 filed on Nov. 18, 2014, which is hereby incorporated herein by reference in its entirety.

### FIELD

The present invention relates to sports gaming, and, more particularly, to an engine, system and method for providing fantasy sports play.

### BACKGROUND

Fantasy sports have become an exceedingly popular pastime for many persons around the world. Typically fantasy sports are played by a fantasy game player selecting one or more players in a given sport to form a team of players. Those sport players accumulate statistics based on their real performances in live-action games and then the objectively measurable performances are assigned certain score values according to game rules. The aggregate score achieved by the team if players can then be compared to other “teams” in a given fantasy league as part of daily, weekly, seasonal or other periodic game play.

However, fantasy sports play conventionally requires live game play. As a result, fantasy play for a given sport is limited in time to the active live season of that sport. In other words, a fantasy game player cannot currently compete in fantasy game play year round in any one sport of their choice. Therefore, waiting for a new season to begin can be frustrating and can lead to persons losing interest. Moreover, revenue collected by purveyors of fantasy sports gaming experience corresponding seasonal revenue peaks and valleys.

In addition, the participants in the actual sporting events have limited careers in their sport, so eventually they will retire, or they may become injured in a given season. As a result, key players and favorite players for a particular fantasy sports player can be lost over time and even in a given season.

There are also insufficient numbers of active sports players for each team in live action games for a fantasy sports player to field an entire fantasy sports team from just one real team affiliation.

Therefore, the need exists for a fantasy sports apparatus, system and method that allows for the playing of fantasy sports that includes players not actively playing in the real time games. Fantasy sports statistics may be accumulated: in the off-season of the relevant actual sport; for retired or inactive players; for favorite players or teams, or the like. Such a fantasy sport may occur in a league mode, in a one-on-one mode, in a player on player mode, in a group of player or positional players versus like-positional players mode, or the like.

### SUMMARY

The present disclosure provides at least a gaming architecture apparatus, system and method suitable for providing fantasy sports play. The apparatus, system and method may provide for accessing, from at least one network-accessible remote memory store, a plurality of outcome data indicative of player performance of real world sports play correspondent to the fantasy sports play, wherein the plurality of outcome data accessed at least partially comprises historical player performance data. Further provided may be a transforming of the plurality of outcome data to fantasy sports play data agnostically to an active or inactive status of the real world sports play, and a determination of an outcome of the fantasy sports play at least partially in accordance with the fantasy sports play data.

Further provided may be a controlling of the transforming in accordance with a plurality of indicated preferences for the fantasy sports play. The real world sports play may be selected from baseball, football, basketball, hockey, lacrosse, soccer, golf, wrestling, and a non-sport.

Further provided may be a populating of players of the real world sports play onto teams for the fantasy sports play. The populated players may at least partially comprise inactive players. Networked content, such as video content, regarding the populated players may be provided.

The plurality of outcome data may comprise a respective bell curve for each real world player. The bell curve may be respective to a single reason of the real world sports play. The bell curve may comprise divisions of single games of a single season of the real world sports play. The bell curve data may be randomly or quasi-randomly accessed for fantasy sports play.

By way of non-limiting example, the fantasy sports play may comprise at least one of daily, weekly, or full season league play; one-on-one daily, weekly, or full season play; individual challenge play; pick 'em play; or bracket play. The fantasy sports play may comprise play pace substantially correspondent to real time play of the real world sports play.

Accordingly, the disclosure provides a fantasy sports apparatus, system and method that allows for the playing of fantasy sports, in real time or not in real time, in which fantasy sports statistics may be accumulated: in the off-season of the relevant actual sport; for retired or inactive players; for favorite players or teams, or the like.

The disclosure includes a fantasy gaming system. The system includes a database containing inactive sports player performance data and a gaming computing engine located remote from the database and coupled to the database by a network. The gaming computing engine may be configured to access a set of inactive sports player performance data according to a set of parameters from the database; transform the set of inactive sports player performance data into a simulated fantasy sports play data set; and determining an outcome of a fantasy sports game based upon the simulated fantasy sports play data set.

The gaming computing engine may be further configured to combine a set of active player performance data with the simulated fantasy sports play data set. The determination of the outcome may be based upon the combined active and simulated fantasy sports pay data set.

The gaming engine may be further configured to deliver a video clip to a user equipment. The video clip can correspond to one or more plays from the simulated fantasy sports play data set.

The disclosure further includes a gaming software code architecture suitable for execution by at least one computing processor for providing fantasy sports play. The architecture may include a first code segment for accessing, from at least one computing memory store network accessibly remote from and associated with the at least one processor, a plurality of outcome data indicative of player performance of real world sports play corresponding to the fantasy sports play. The plurality of outcome data accessed at least partially can include historical player performance data. A second code segment may be provided to transform the plurality of outcome data to fantasy sports play data agnostically to an active or inactive status of the real world sports play. A third code segment can be provided to determine an outcome of the fantasy sports play at least partially in accordance with the fantasy sports play data.

The above summary is not intended to limit the scope of the invention, or describe each embodiment, aspect, implementation, feature or advantage of the invention. The detailed technology and preferred embodiments for the subject invention are described in the following paragraphs accompanying the appended drawings for people skilled in this field to well appreciate the features of the claimed invention. It is understood that the features mentioned hereinbefore and those to be commented on hereinafter may be used not only in the specified combinations, but also in other combinations or in isolation, without departing from the scope of the present invention.

### BRIEF DESCRIPTION OF THE DRAWINGS

The accompanying drawings are included to provide a further understanding of the disclosed example embodiments.

FIGS. 1a-1d illustrate aspects of exemplary embodiments of the present invention.

FIG. 2 illustrates aspects of an exemplary embodiment of the present invention.

FIG. 3 illustrates aspects of exemplary embodiments of the present invention.

FIG. 4 illustrates aspects of exemplary embodiments of the present invention.

FIG. 5 illustrates aspects of exemplary embodiments of the present invention.

FIG. 6 illustrates aspects of exemplary embodiments of the present invention.

FIGS. 7a-7b illustrate aspects of exemplary embodiments of the present invention.

FIGS. 8a-8g illustrate aspects of exemplary embodiments of the present invention.

FIGS. 9a-9b illustrate aspects of exemplary embodiments of the present invention.

FIGS. 10a-10o illustrate aspects of exemplary embodiments of the present invention.

FIGS. 11a-11g illustrate aspects of exemplary embodiments of the present invention.

FIG. 12 illustrates aspects of exemplary embodiments of the present invention.

FIGS. 13a-13b illustrate aspects of exemplary embodiments of the present invention.

FIG. 14 illustrates aspects of exemplary embodiments of the present invention.

FIG. 15 illustrates aspects of exemplary embodiments of the present invention.

FIGS. 16a-16c illustrate aspects of exemplary embodiments of the present invention.

FIG. 17 illustrates aspects of exemplary embodiments of the present invention.

FIG. 18 illustrates aspects of exemplary embodiments of the present invention.

FIG. 19 illustrates aspects of exemplary embodiments of the present invention.

FIGS. 20a-20c illustrate aspects of exemplary embodiments of the present invention.

While the invention is amenable to various modifications and alternative forms, specifics thereof have been shown by way of example in the drawings and will be described in detail. It should be understood, however, that the intention is not to limit the invention to the particular example embodiments described. On the contrary, the invention is to cover all modifications, equivalents, and alternatives falling within the scope of the invention as defined by the appended claims.

### DETAILED DESCRIPTION

In the following descriptions, the present invention will be explained with reference to various exemplary embodiments. Nevertheless, these embodiments are not intended to limit the present invention to any specific example, environment, application, or particular implementation described herein. Therefore, descriptions of these example embodiments are only provided for purpose of illustration rather than to limit the present invention.

The present disclosure provides, for any given fantasy sport, including for example, baseball, football, basketball, hockey, lacrosse, soccer, golf, wrestling, horse racing, Olympic events, or any other sport, a fantasy sport season that may be agnostic to: the actual season for the relevant sport; the available players then presently active in the relevant sport; the actual game time of the relevant sport; and the like.

The disclosed fantasy sports apparatus, system and method may optionally include a draft, auction or other player population methodology. The population methodology can include active players in season in the relevant sport, active players out of season in the relevant sport, inactive players in the relevant sport, combinations thereof, etc. Further, as used herein, “fantasy sports” or “fantasy games” may not only include athletic events, but may additional include non-real world comparative “games” in other contexts, such as in relation to celebrities (i.e., celebrity dating “betting” games), financial performance, computer gaming, politics, or the like.

More particularly, the present disclosure may include, for any players in any given sport for which data is available, or for which statistics are currently being incurred, a set of “bell curve data” for use in a fantasy sports context, wherein the bell curve data set may include data for a particular season, a particular season to date, a career, a portion of a career, a particular year or years (such as only pro bowl seasons for a football player, or only championship seasons for baseball player, or only all-star seasons for a baseball player, etc.), a simulated season or portion thereof, and the like.

This bell curve data may be stored in non-transitory form in a memory, computer database or other storage device, either locally or remotely, and accessed by the gaming engine via a network interface. One or more fantasy players uses their own computing device (e.g. personal computer, smartphone, tablet, etc.) to interact with the gaming engine over the internet by executing a web application or a software application stored locally on the user's computing device.

The user's application displays an interactive fantasy sports graphical user interface (GUI). By interacting with the GUI, the fantasy sports player can populate their team in a known manner, such as by a draft as mentioned above. Further, the fantasy sports player can use their GUI app to compete in fantasy sports play in a one-on-one daily, weekly, or full season format, in a league-based daily, weekly, or full season format, in a particular selected challenge or “pick 'em” format, or in a like format known to the skilled artisan, by way of non-limiting example.

Fantasy teams, once populated, may play in a variety of presently known and unique formats, as mentioned immediately hereinabove, and may play in what would typically be understood as a “real time” format for a fantasy game of the given sport, i.e., wherein the fantasy game takes the same amount of time as an actual real world game or games. Or the game play can proceed at an expedited pace, i.e., wherein a time for accrual of fantasy statistics does not match the time of a real world game. The timing format of a fantasy game may be selected by the fantasy sport gaming engine disclosed herein automatically, may be indicated by a commissioner or administrator of the fantasy sports play through the aforementioned GUI, or may be manually selected by the fantasy sports players through the aforementioned GUI, by way of non-limiting example.

Once a fantasy game is under way, the bell curve data for the given time frame of the fantasy game, i.e., for each real world player's prior selected season, current season, portion thereof, position, statistical category or categories, team, comparative performance versus a given statistic or average statistic, or the like, may be accessed by or provided to the fantasy sports engine from the computer memory that is local or remotely available on a server or other computer system via a network, as mentioned previously. The fantasy sports engine may then randomly select data from the bell curve data set, such as based on the criteria set for data selection, i.e., what data is the pool from which data is to be selected, format of data to be selected, how quickly is data to be selected or displayed, etc.

By way of non-limiting example, the data set may be selected randomly (or quasi-randomly based on an algorithm also stored in a computing memory associated with the fantasy sports engine) from or in any format, such as by game minute for the real world player's selected season, by game quarter, by game inning, by game half, by game, by season portion, by season, by career, by category, by simulation, or the like. Data may also be selected, for example, based on other comparisons or criteria applied by a then-present fantasy game, such as wherein data is selected from a retired, Hall of Fame real world player's bell curve based on his career games against a defense playing on the opposing fantasy team. That is, the presently disclosed embodiments may access bell curve data, such as previously accrued real world bell curve data, estimated bell curve data, fictitious bell curve data, or the like, in a randomized manner, for any reason and over any time frame, and may transform the resulting compiled data set to fantasy points according to the applicable scoring rules employed in a selected fantasy format and time frame, such as in an approximately real time fantasy game (wherein approximately real time may be the approximate time a real world game would have taken, such as excluding commercial breaks, timeouts, and halftime).

Point totals for fantasy points per team may then be compared in the selected fantasy game format, such as in a rotisserie format, one-on-one or one-on-one categorical format, a pure points format, or the like, to select a winner of the fantasy game for the selected time frame for the selected fantasy game in the selected fantasy sport. Accordingly, based on the presently disclosed random selection from bell curve data, off-season fantasy games, “legends” fantasy games, or blended league games (such as in which currently active in-season players and inactive players are available together, for example) may be provided.

Various other and additional features that are frequently included in fantasy games may likewise be included in the presently disclosed fantasy game. By way of non-limiting example, video clips corresponding to plays that are part of the bell curve data set for each player for each of the simulated “real time” games can be played together as a simulated “live game” or can be accessed on a user-selected basis to see specific scoring plays of the user's interest.

The highlights can also be provided for game recaps that the user may select post-completion of the “live” games, for both live action players and for the simulated “live” players.

Various different criteria may be placed upon the selection of players to provide such fantasy play, such as wherein a fantasy sports coach/player is limited to only selecting active and/or inactive real world players from that fantasy coach's indicated favorite team or teams, by way of non-limiting example. Correspondingly, an available real world player pool may be indicated, such as by institution by the fantasy sports engine, such as based on a selected fantasy game format, or by fantasy sports league commissioner, by way of example.

In the latter format, by way of non-limiting example, a fantasy sports league may have available to its coaches only those players and teams from a certain era, such as the NFL in the 1980's, either by career, statistics from the 80's, a particular year of the 80's, or the like. As such, the first player (drafted) in such a format might be quarterback Joe Montana, the second player selected might be running back Walter Payton, the third player selected might be the 1985 Chicago Bears defense, and so on. Moreover, the randomized bell curve data set selection algorithm for the teams or players, whether or not limited by certain criteria, may have associated therewith particular additional criteria in order to ensure the statistical significance of the bell curve data. By way of non-limiting example, the fantasy engine may require that the bell curve data be comprised of at least thirty games played in the era to which the game is limited.

Thus, the apparatus, system and methods of the instant disclosure may provide for numerous different types of fantasy sports games, such as traditional seasonal leagues, daily fantasy leagues, weekly fantasy leagues, one-on-one or player-on-player challenges, fantasy sports bracket play, and the like, using randomized, bell curve data generated from past games, currently live games, combinations thereof, etc. Thereby, play by play fantasy game action may be simulated (in real time or non-real time) and/or may include current action data, and may be delivered as a partial or total simulation to simulate live fantasy sports match-ups as would occur for exclusively active players during a typical season of that sport. Moreover, video can be provided to the fantasy player/coach that corresponds their players, and opposing teams' players, that corresponds to each play or score compiles by each player on a given fantasy team.

Certain embodiments provide various unique capabilities and commercial aspects. For example, fantasy sports play may occur out of season or after a real world player is no longer active. Fantasy sports coaches/players may use favorite players, teams, portions of teams, or the like, such as from a historical perspective, or from a blended historical and currently active perspective. Highlights and other features typically provided by known fantasy sports engines may likewise be provided in the instant invention. Accordingly, partnerships may occur with former players' associations, sports leagues, video archivers, and the like.

Revenue generation may thus occur in the disclosed embodiments using a typical fantasy sports model, wherein a percentage of entry fees are collected; using transaction fees, such as for one-on-one challenges, to allow for fantasy game in-game player changes, and the like; using sponsorship fees; and/or by providing video highlights, box scores, and the like for fees, including providing the foregoing for historical players, from various external third-party networked databases, and the like.

The fantasy sports made available in the instant disclosure may include college and professional sports (or the equivalent) of any type, or other known non-sports fantasy games. The instant invention may be provided as a unique GUI, a standalone or integrated “app”, a web accessible (such as a Web-based) engine, or as an integrated or stand-alone feature associated with a third-party fantasy sports gaming platform already known to those skilled in the art.

The gaming engine and the user's computing device can both be computing devices comprising a processor, non-transitory memory and software code stored in the memory to execute the specific functions and features of each of the respective gaming engine and user computing device. The bell curve data can be stored on one or more remotely located database computing device. Likewise, the video clips can be stored on one or more remotely located computing devices. For example, a computer, tablet, or smartphone can form the physical apparatus according to the invention, or such hardware can be used to perform the methods and techniques disclosed herein.

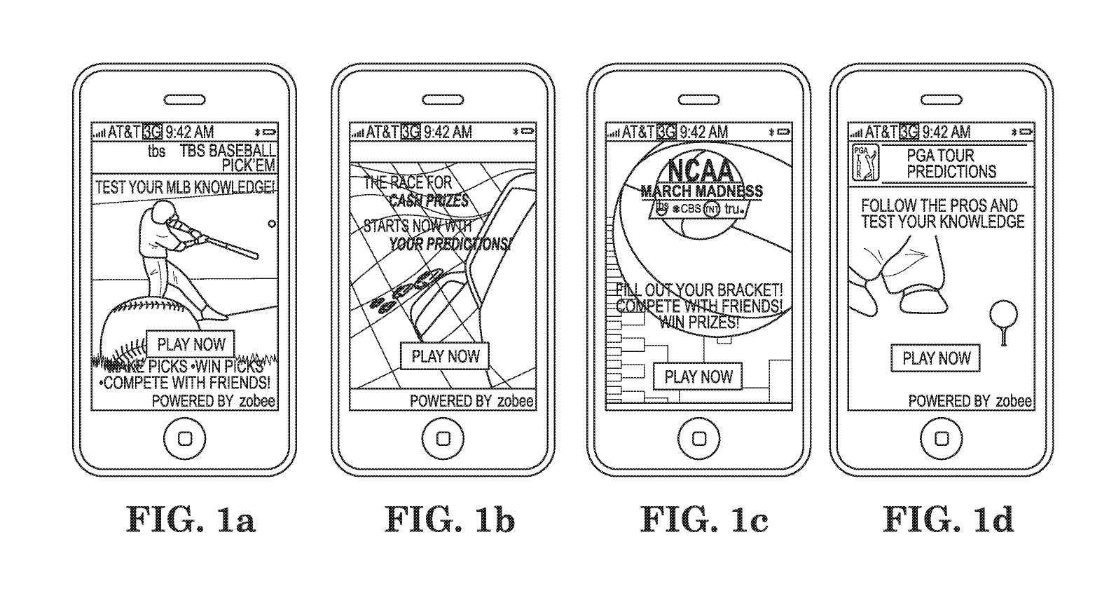

Referring now to FIGS. 1a through 1d, a user computing device is shown that illustrates a plurality of entry GUI screens to play a fantasy sport in accordance with the instant disclosure. At the outset, and following selection of the game to be played, a draft, auction, or other player selection methodology, and the corresponding limitations and criteria related thereto, may occur. This player or game selection may be upon agreement of the fantasy sports players, may be made by a commissioner or administrator, or the like.

Criteria and configuration options for player selection may include, but are not limited to: allowing in-game roster moves; number of teams; points system used; duration of the league; availability of one-on-one positional or statistical challenges; limitations on years, teams, and the like; period for randomized data selection from the bell curve, such as quarters, innings, minutes, and the like; availability of in-game roster changes, and availability of post-game indication or in-game indication of where the randomized or quasi-randomized bell curve data is being selected from, such as may be indicated by video highlights or the like.

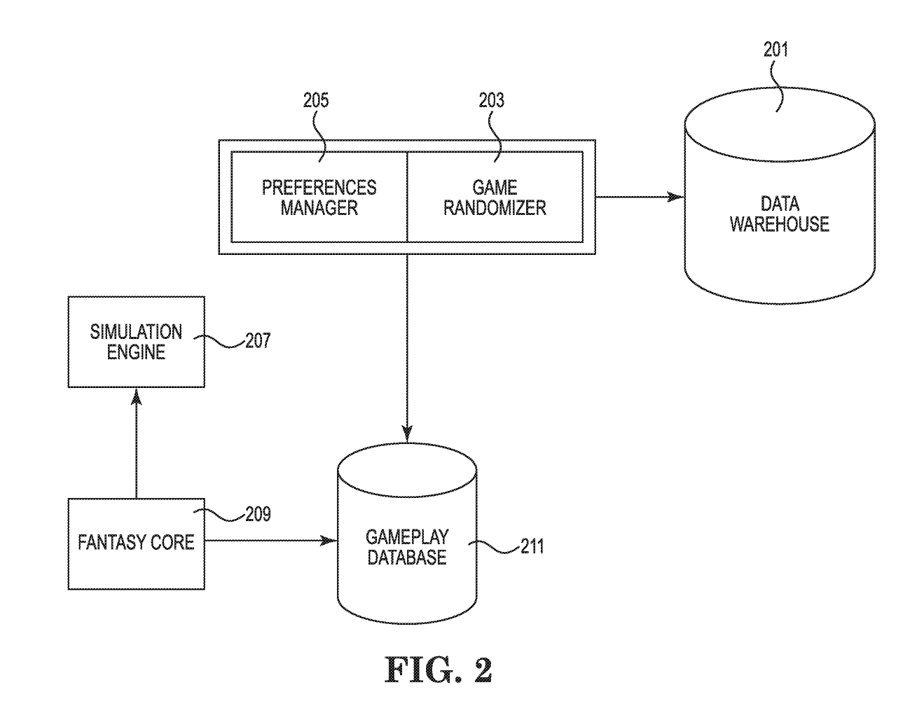

FIG. 2 is a diagram of aspects of the system including the bell curve data storage and data selection/randomization architecture. The bell curve data set is stored in the data warehouse 201 (e.g. database computing device). There may be more than one data warehouse in a given system. The data ware house can be integrated into the gaming engine 207 or it can be a database located physically remote to the gaming engine and accessed via a network.

The data set stored in the warehouse(s) may be by any timeframe for any player, and for any sport. The data set may be date from any one or more levels, such as at the box score level, play by play level, or the like. The data can be in any suitable database format for access by the gaming engine.

The bell curve data sets retrieved from the data warehouse 201 may be experienced as fantasy game play using a randomization engine 203, discussed further hereinbelow, which may engage in a randomized or quasi-random selection of the data in view of entered game preferences (e.g. data level, data timeframe, speed of play, etc.) as may be entered into and managed by a preferences manager 205. For example, the bell curve data sets may be extracted by the gaming engine to provide an experience that replicates, or substantially replicates, live game data generation, such as with or without commercial breaks and other game pauses, The data can be extracted in its entirety instantaneously; and/or may occur as it would in real time, such as over an eight hour period on a Sunday, or the like.

The bell curve data sets may include limitations to ensure statistical significance, such as minimum numbers of games in a season for a selected player to allow for selection of data from that season, or the like. That is, the bell curve data may or may not be selected, in accordance with the rules applied by the fantasy sports engine discussed herein, to include games in which a player was injured or removed from the game, games in which the player was declared inactive proximate to game time, or the like.

Moreover, and as illustrated in FIG. 2, a simulation engine 207 may simulate (if needed, e.g., if live data feeds are not used in their entirety) a fantasy game. The fantasy game may play in conjunction with a fantasy sports game engine (core) 209, as discussed in this disclosure, with points, winners, and the like occurring from a gameplay database 211 that stores data relating to the fantasy gameplay inputs and results.

As discussed throughout, and as indicated in FIG. 2, a randomizer/preferences manager 203, 205 may be coupled to the bell curve data storage 201. The randomizer engine 203 may be a software code segment stored in memory and executed by a processor of a computing device. The randomizer engine 203 has associated therewith a plurality of data selection rules and preferences stored in memory and executed as software code by the processor of a computing device.

The randomizer 203 queries the bell curve database 201, and, based on the rules elected for application in a given context, randomly (or quasi-randomly) selects the relevant data to form a game play data set in accordance with the relevant criteria of the rules. The randomizer may include limitations on the bell curve data that may be selected, such as ensuring that data for more than one quarter is not selected from the same game, the same quarter is not selected twice in a single fantasy game (or season), the same season is not selected twice in the same fantasy game, extra inning games are not selected twice in the same fantasy game, or the like, by way of non-limiting example.

The randomizer 203 and/or the simulation engine 207 and/or the fantasy gameplay engine 209 may additionally make selections that allow for acceptable or desired game play. For example, if a league has an insufficient number of teams, or an odd number of teams, notwithstanding that the coaches in the league may have sent, such as through the instantly disclosed apparatus, system and method, invitations to participate in the league to friends, the randomizer, simulation, or gameplay engines may “play” as a particular team in a given league. This automated team may play for a single game, a single week, an entire fantasy season, or the like.

Each of the physical components of FIG. 2 can be computing devices as discussed previously. Each computing device employed executes one or more software code segments to accomplish the functionality of the device or component as described herein. One or more the system components can also be integrated so that the functions of one or more components can perform the stated functions of multiple devices. For example, the game randomizer 203, preferences manager 205, simulation engine 207, fantasy core engine 209 and gameplay database 211 may all be included in the same single computing system with respective software code segments to accomplish the functionality of each component. Alternatively, each of these components can be performed by a separate computing system, or a combination thereof.

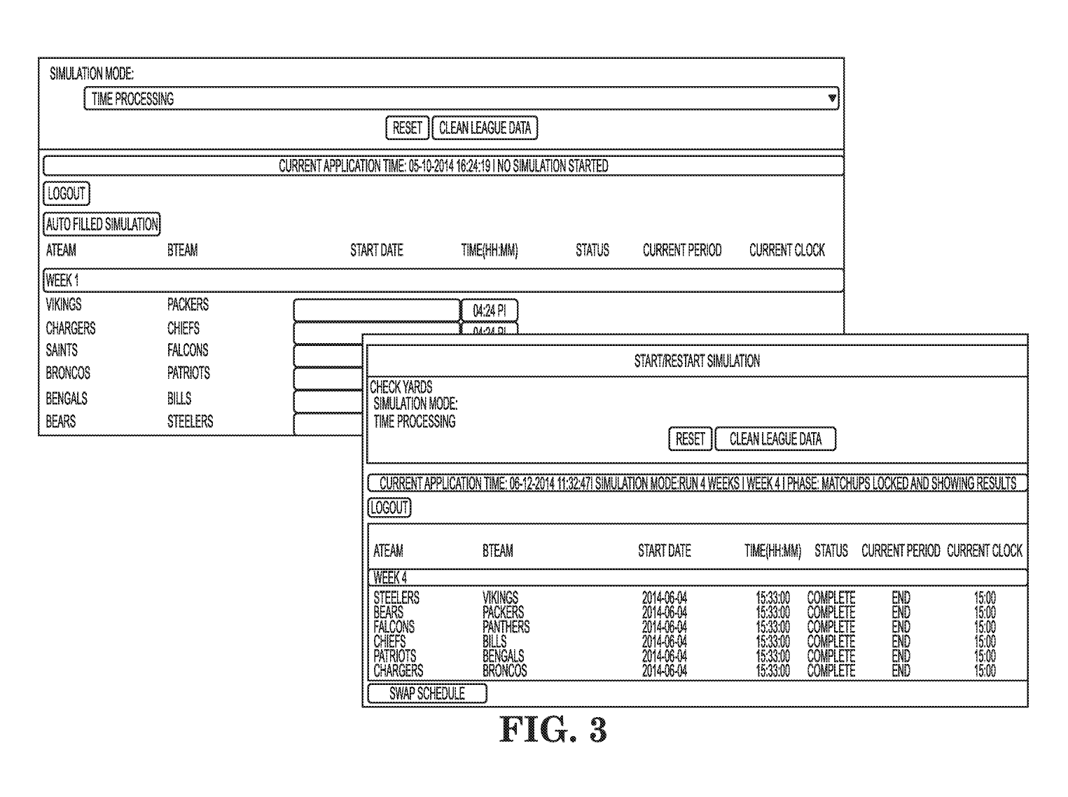

FIG. 3 contains GUI two screens illustrating a game simulation, such as may be provided by the simulation engine 207, fantasy play engine 209, and preferences manager 205, and selection of data, such as may be provided by the aforementioned randomizer.

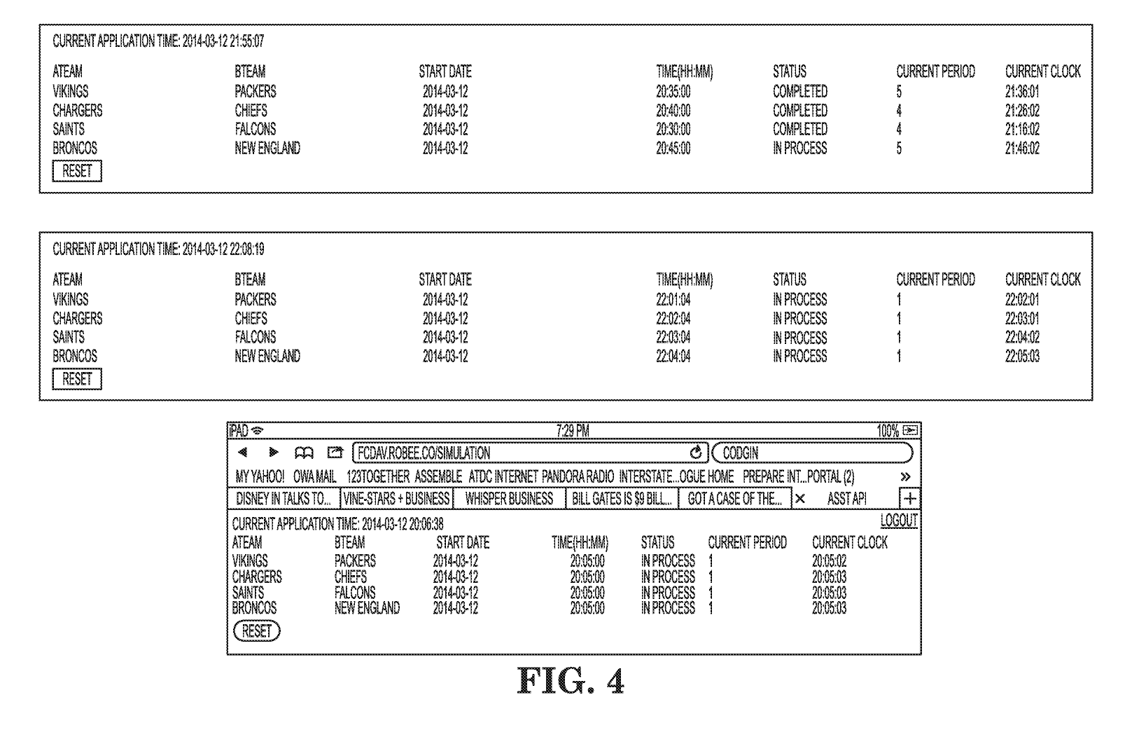

Similarly, FIG. 4 illustrates that a simulation may be synchronous or asynchronous, such as in relation to fantasy or real world game start times.

FIG. 4 further illustrates that a historical game, i.e., one including inactive players, may be simulated as if “in process” in real time, just as would play a fantasy game involving currently active real world players.

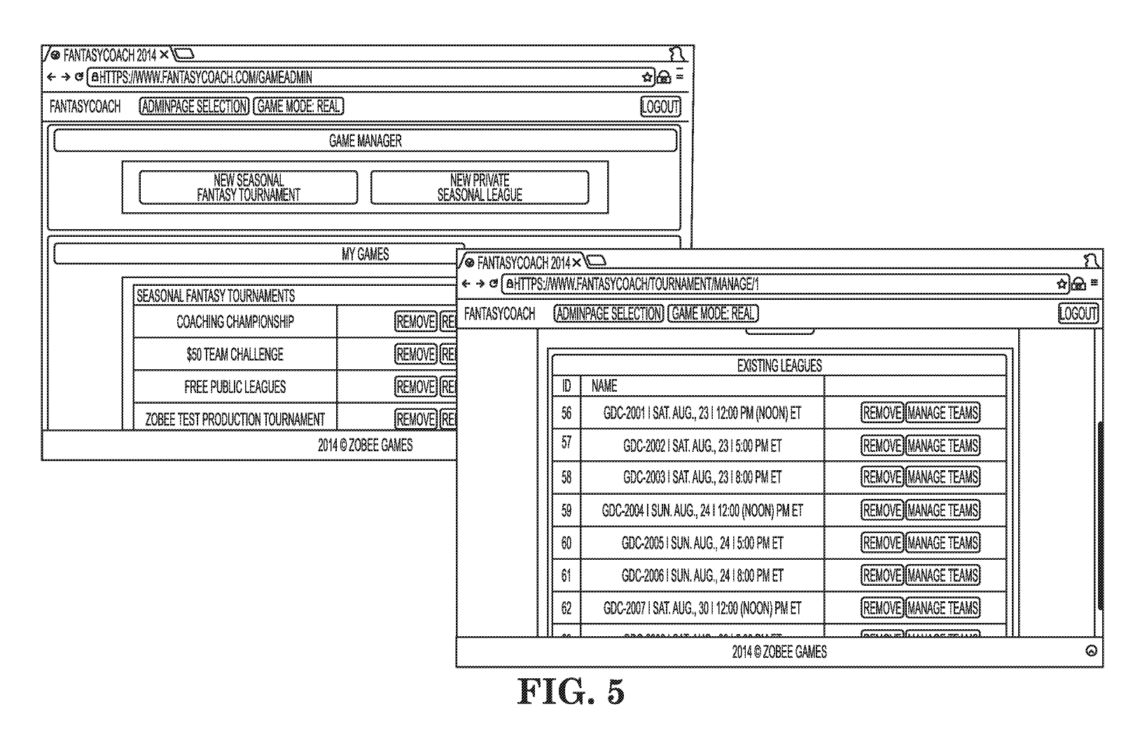

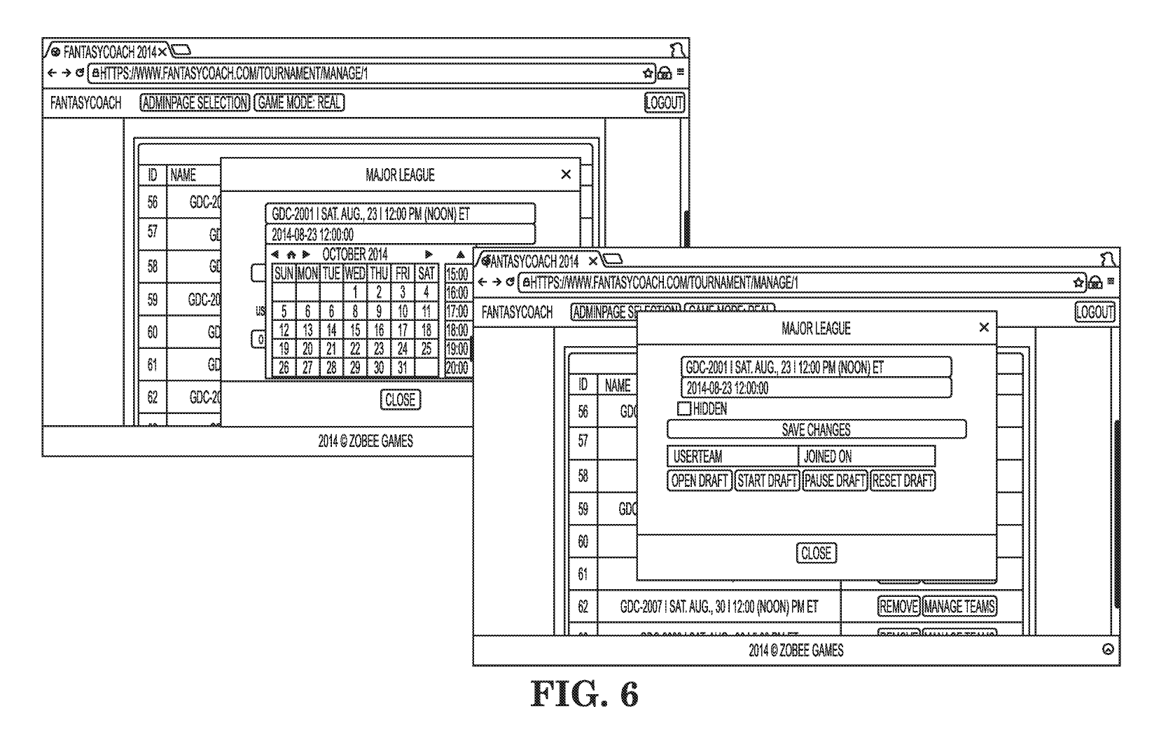

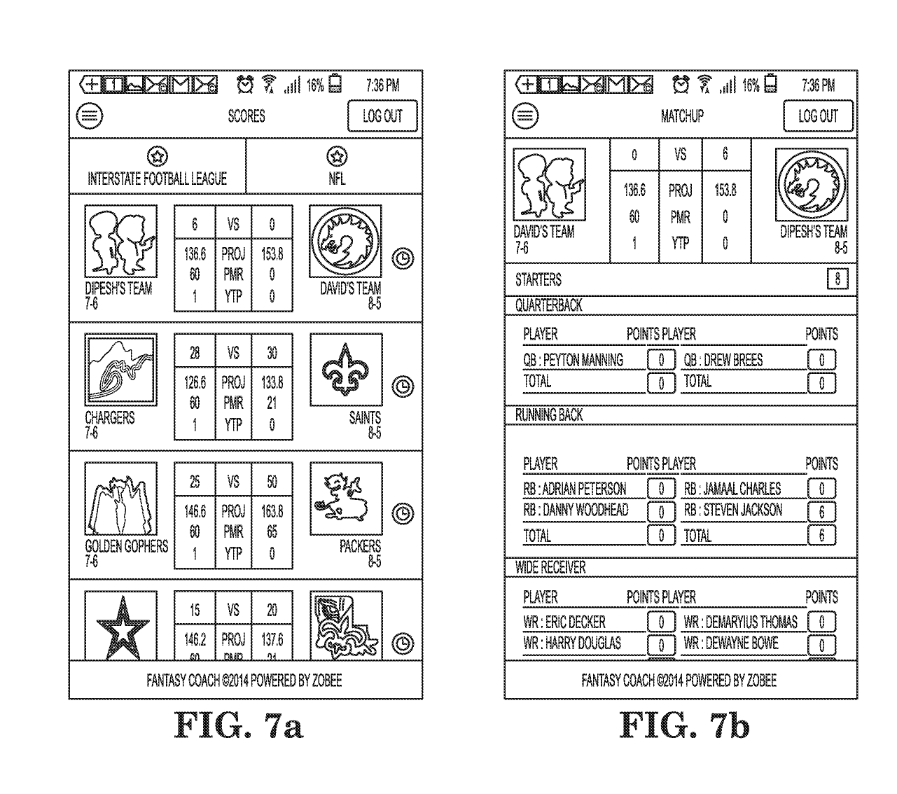

FIG. 5 illustrates two screens of a GUI for a game, league, or tournament manager's interface. A league manager, may, as illustrated in the GUI screens of FIG. 6, manage the league by scheduling a draft for the league in order to populate real world players and as discussed herein. The “manager”, as used herein, may be a commissioner or administrator (as discussed throughout), or may be exclusively with respect to a given team or teams. Once a league is activated by the league manager, for example, players may play in the league using a traditional fantasy sports GUI, such as is illustrated in FIGS. 7a and 7b.

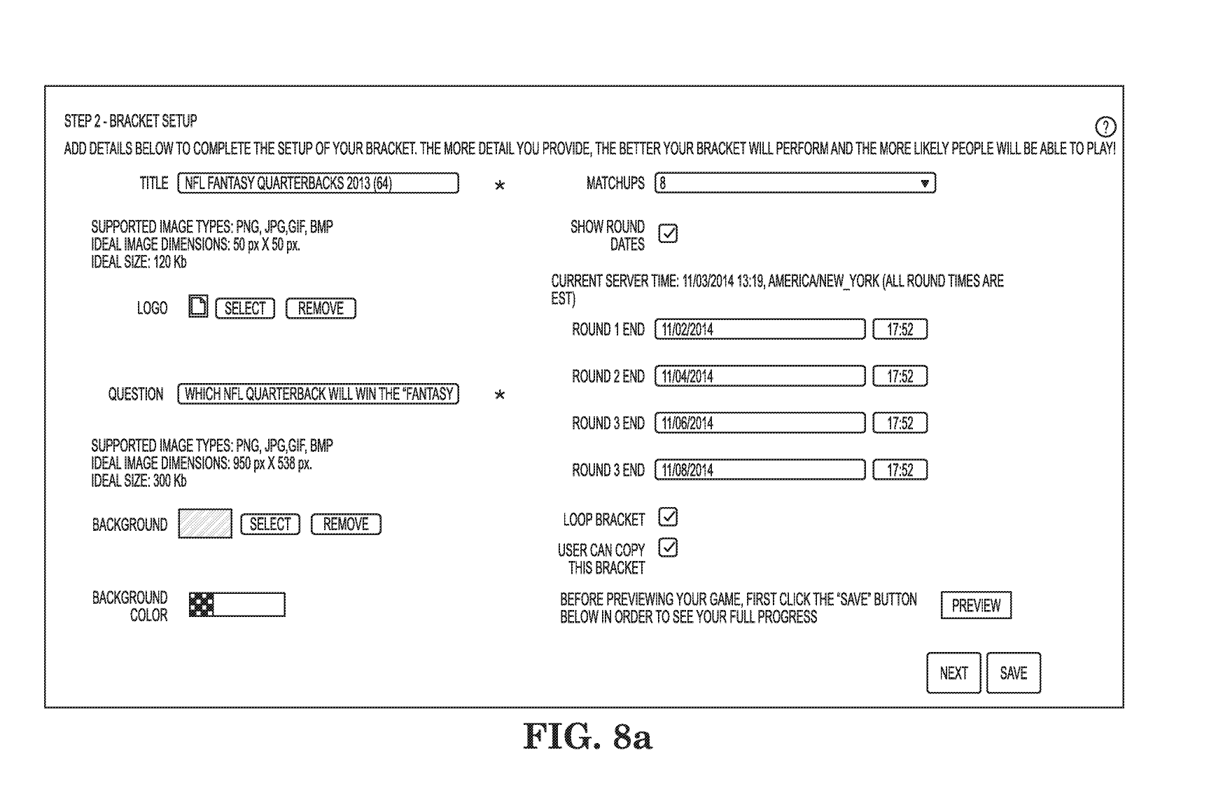

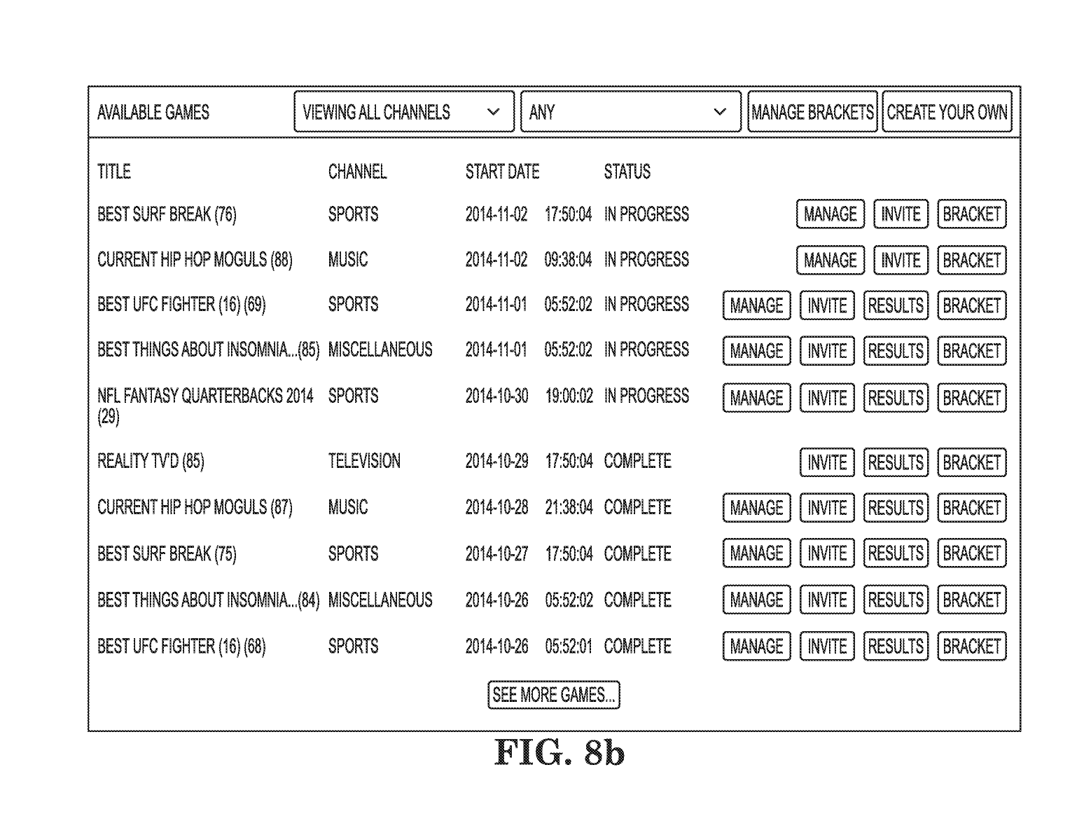

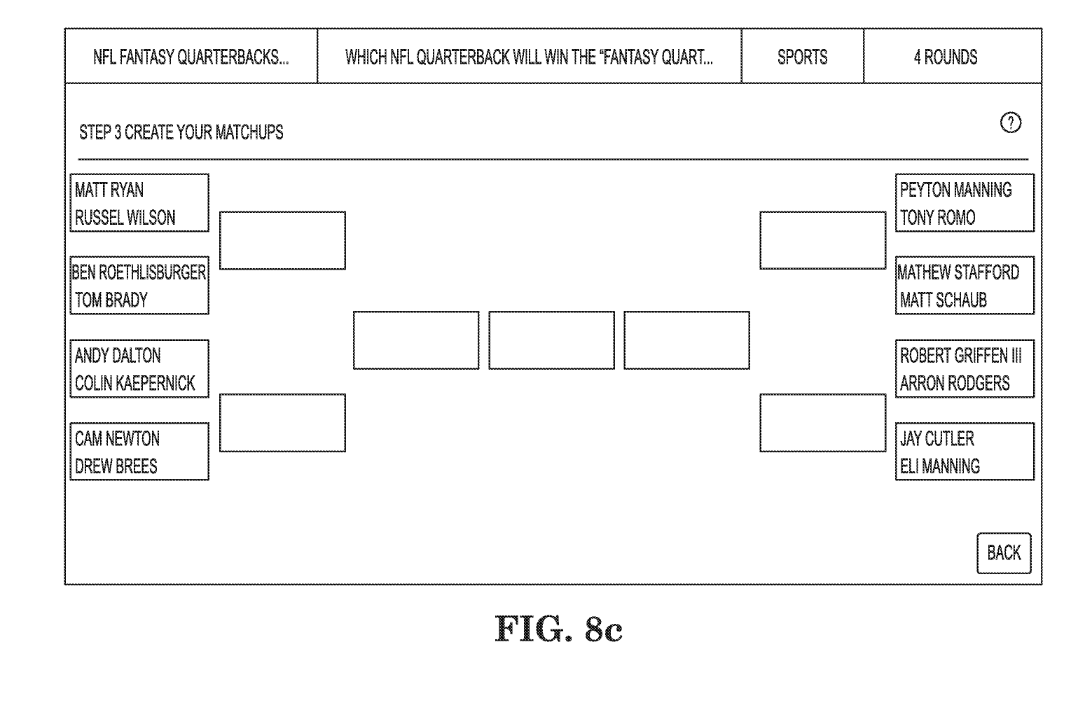

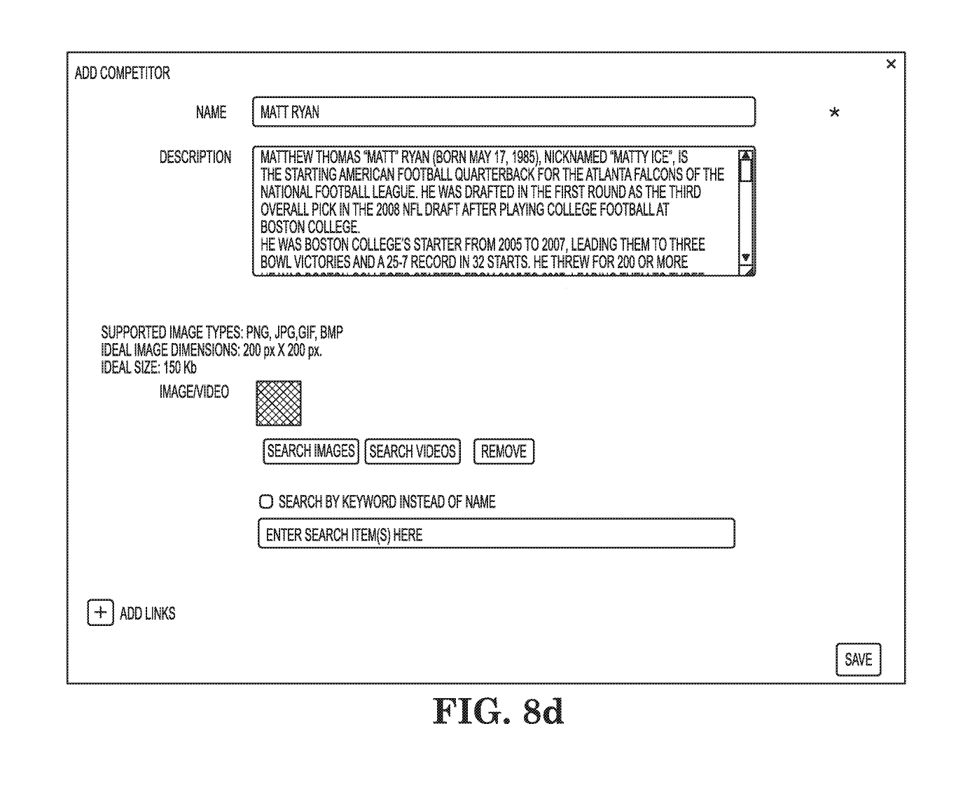

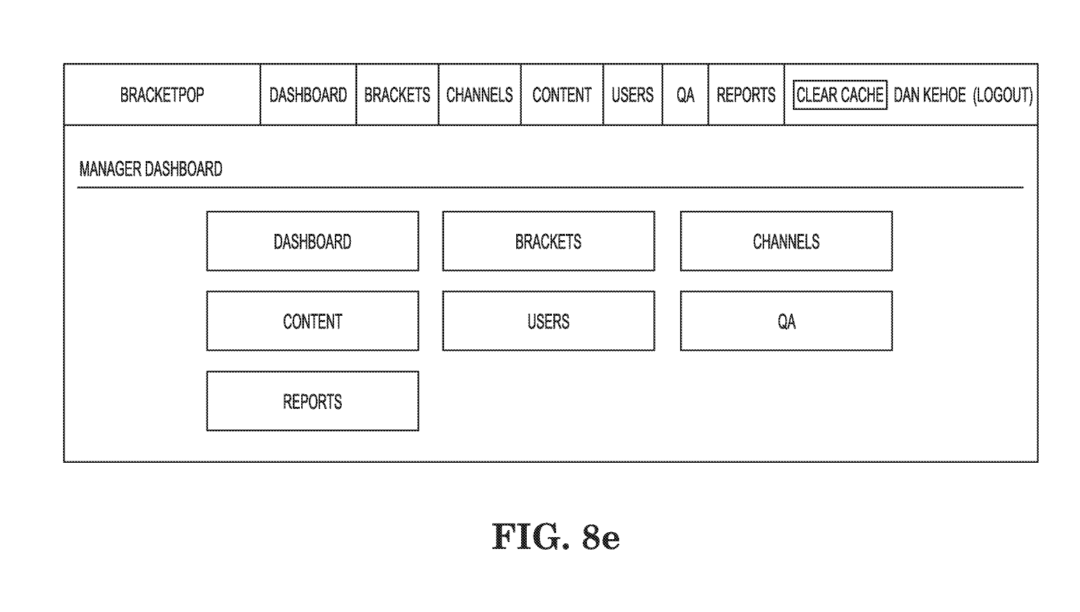

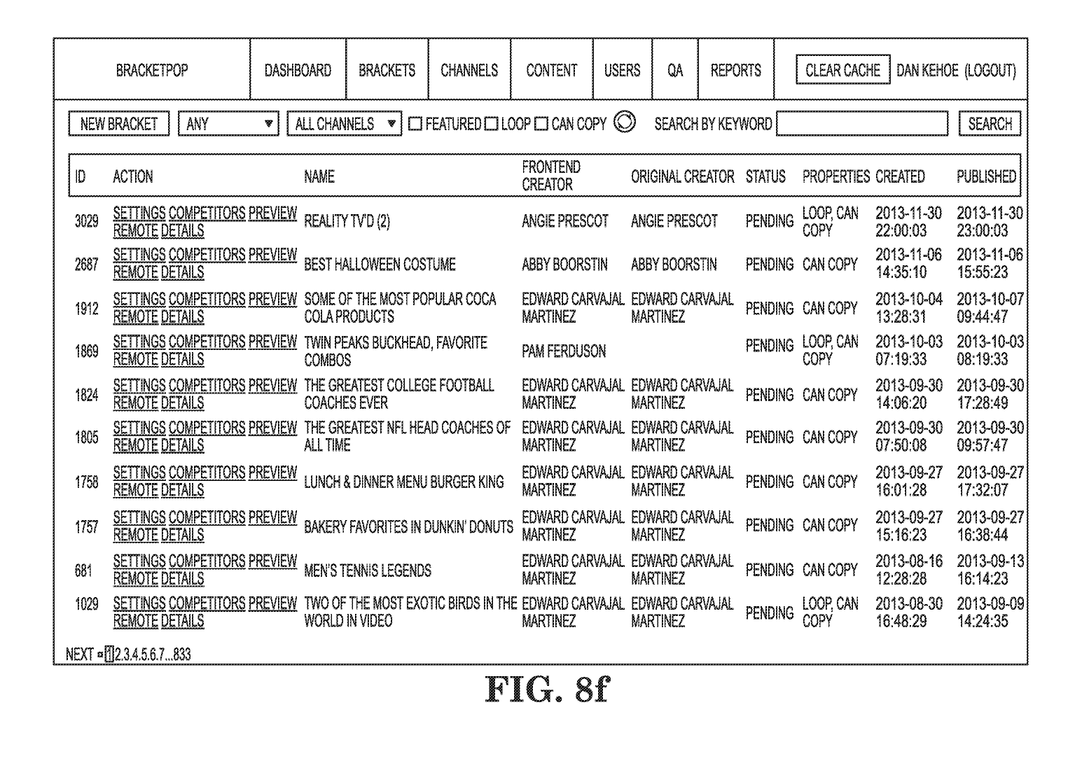

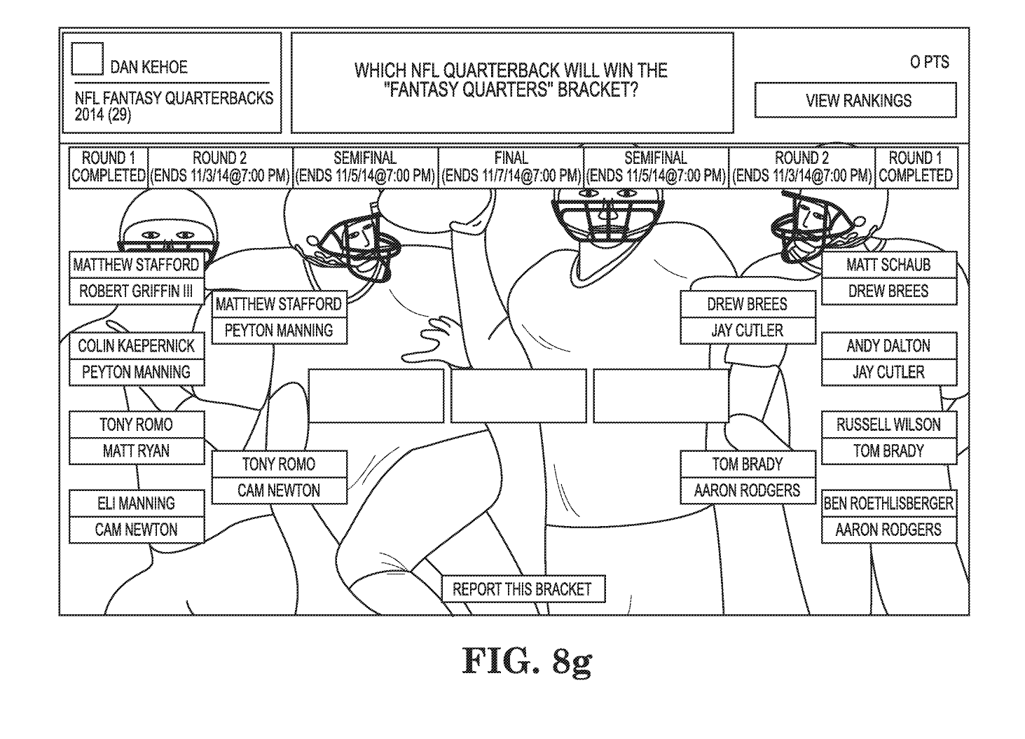

FIGS. 8a and 8b are exemplary illustrations of a league manager GUI for setting up a “fantasy legends” bracket league, that is, a league in which retired real world players at least partially populate fantasy game play. Of course, the league manager may set up a league for fantasy sports play in this or a variety of other formats known to those skilled in the art, or in combinations thereof. For example, fantasy game winners in bracket play may be awarded “points” as “bonuses” available for use in a corresponded rotisserie fantasy game.

As illustrated, “bracket play” may be employed in the present disclosure. That is, real world players (or actors, etc.) may be selected, and “seeded”, such as in matched sets, such as in matched pairs, to allow for comparative advancement by the winner (as against the other seed or seeds in the matched set) to the next stage of the bracket upon winning the competition. The competition may be with regard to any verifiable data drawn from any available data source, such as touchdowns thrown in current actual, or simulated, games or quarters by matched quarterbacks, entered ratings of “best” or “favorite” quarterbacks, or celebrity couples most likely to next get married, by way of non-limiting example. A dashboard to setup and/or track games using any eligible data tracking may be provided, as shown.

For example, FIG. 8c illustrates an exemplary bracket set up for seeded matchup play. In the illustration of FIG. 8c, the matchups may be seeded manually, or may be, by way of non-limiting example, be seeded automated, may be looped or copied, and/or seeding may be randomized. As shown, the bracket may have a number of matchup sets, and a predetermined number of rounds, in addition to a defined competition between the seeds which, when “won” by one seed, allows the winning seed to move to the next round. Alternatively, real world players may re-seed in each round, or available or involved real world players may change as between rounds, or within rounds if in-game roster modifications are available (as discussed elsewhere herein). Further, in additional embodiments, seeds may be manually, or automatically in accordance with rules/preferences, “advanced” to subsequent rounds irrespective of a “win” in a prior round.

FIGS. 8d-8f are GUI screens illustrating administration of a bracket play system. As noted throughout, the bracket play system may have real world players, such as including retired, inactive, and/or off season players, added as long as those players meet the parameters of the fantasy game that is the subject of the bracket. FIG. 8d is an exemplary illustration of the GUI screen for manual addition of a seeded competitor, wherein the added competitor meets the criteria, to a bracket game by, for example, an administrator. The addition of a competitor may, for example, automatically execute a search for that player in data stores, such as in the bell curve data, and/or in live data feeds, such that data related to that player may be accessed for inclusion in the bracket play.

Brackets may be created from, for example, a base dashboard, such as is shown in the GUI screen illustration of FIG. 8e, by an administrator, commissioner, and/or fantasy player/coach. Bracket play may be tracked, such as by an administrator, commissioner, and/or fantasy player/coach, via a manager engine such as that illustrated in the example GUI screen of FIG. 8f. Once executed, a live bracket play may be provided as shown in the exemplary screen embodiments of FIG. 8g.

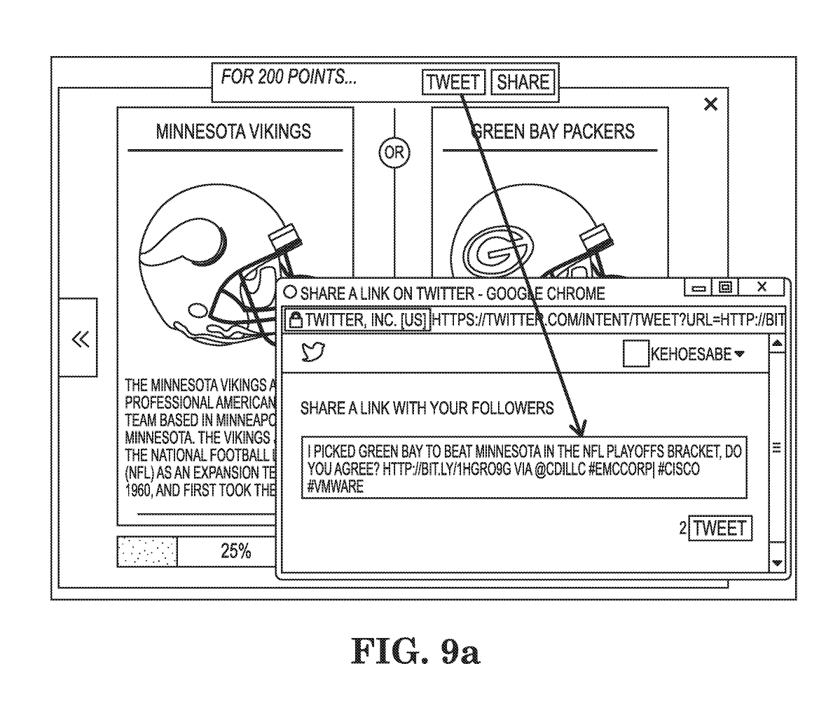

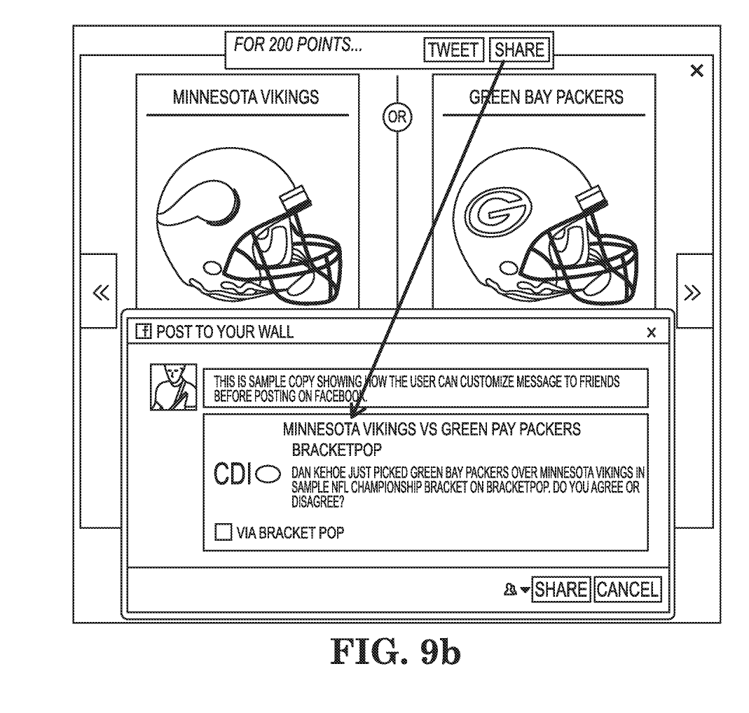

As discussed herein, features typically available in known fantasy sports play may likewise be made available in accordance with the instant disclosure. By way of non-limiting example, FIGS. 9a and 9b illustrate Twitter posts and Facebook posts, respectively, in relation to fantasy sports play according to the instant disclosure. Such availability for “smack talk” may be particularly relevant in the one-on-one formats disclosed herein.

For example, a one-on-one challenge may include a real world player who plays a first position on one fantasy team versus a real world player at the same position on the other fantasy team for a certain competition, such as most fantasy points scored; a challenge that an entire team will accumulate more yards than the other entire team; that one team may have more touchdowns scored than the other team; that any given player will have more touchdowns than any other player at a certain, or any, position on the other team, or the like.

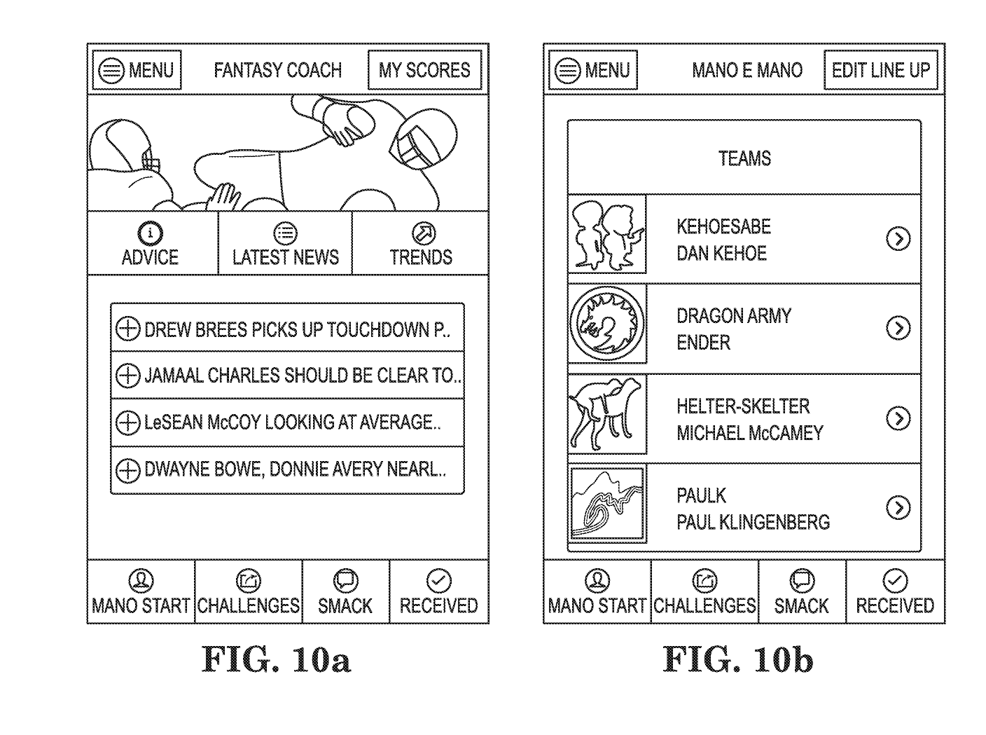

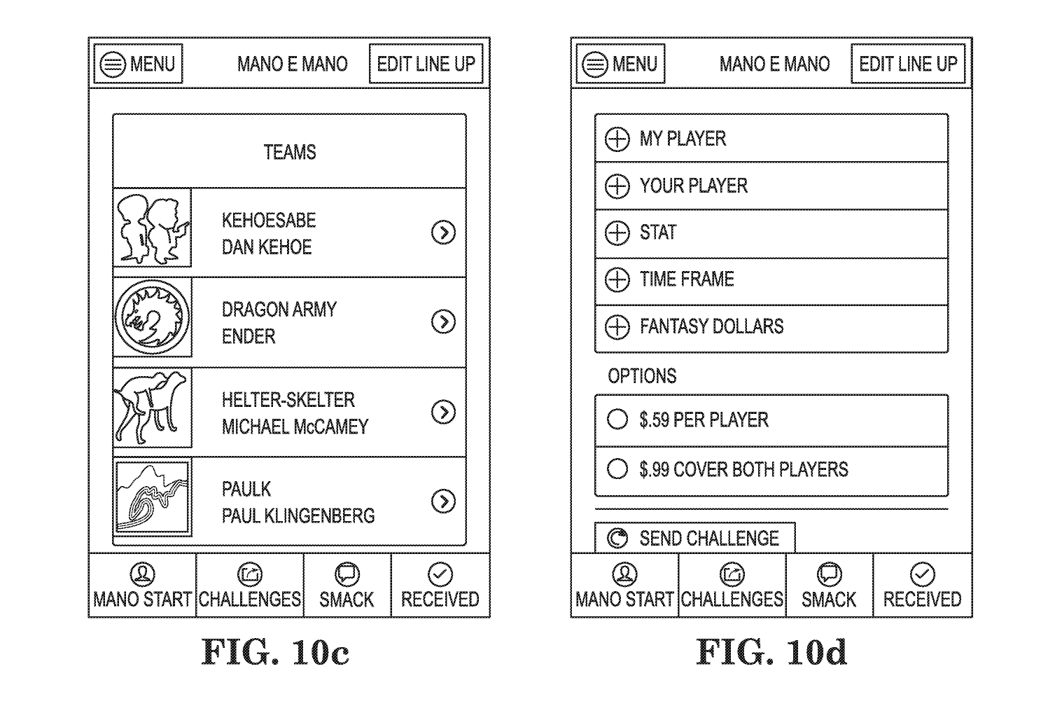

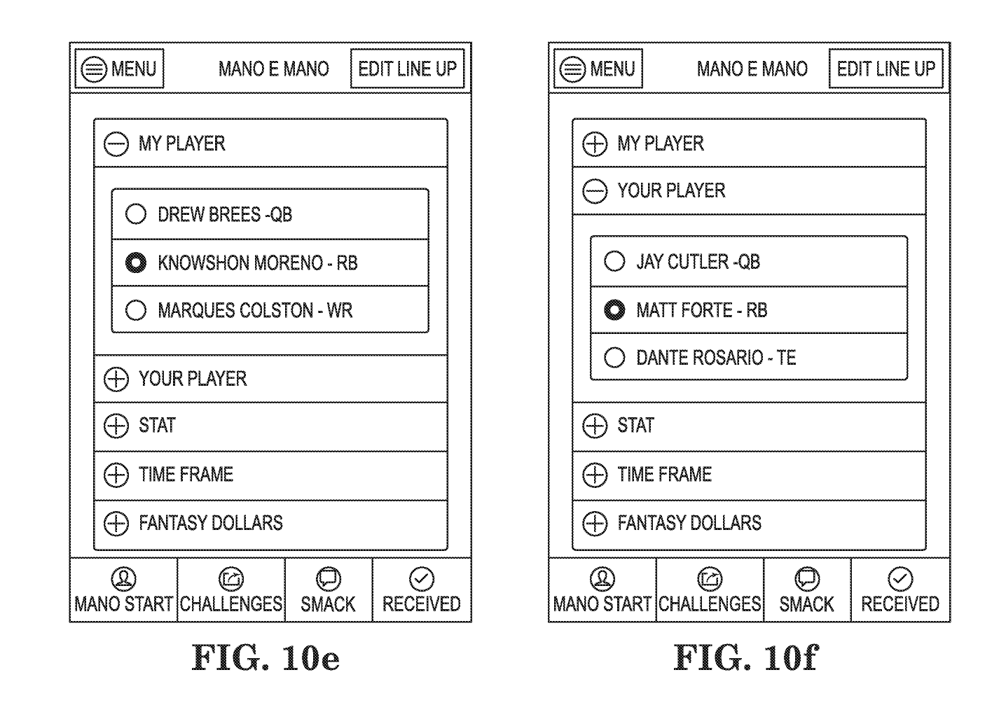

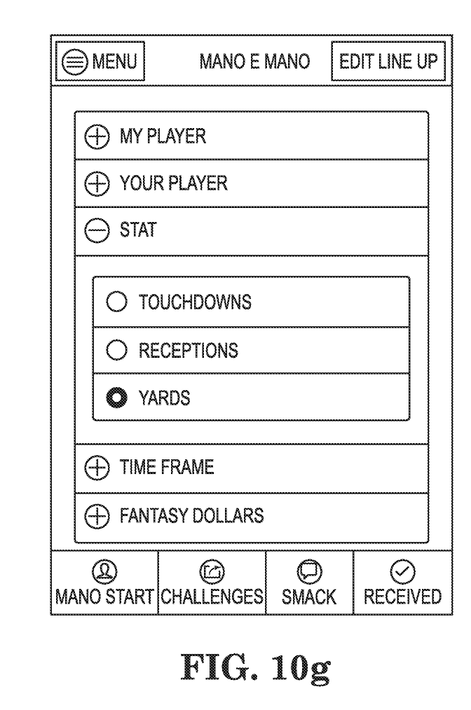

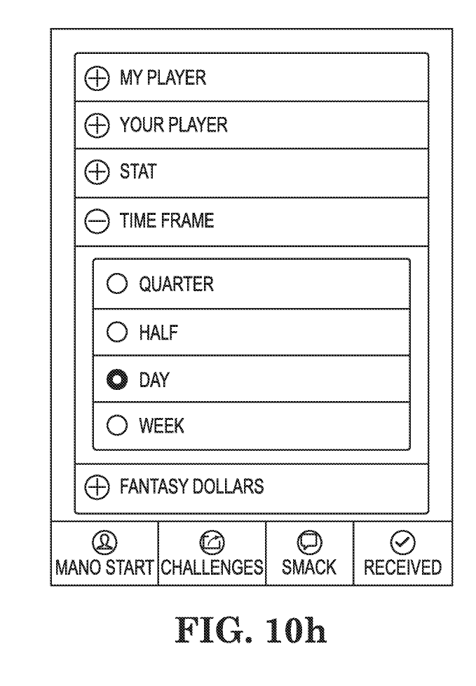

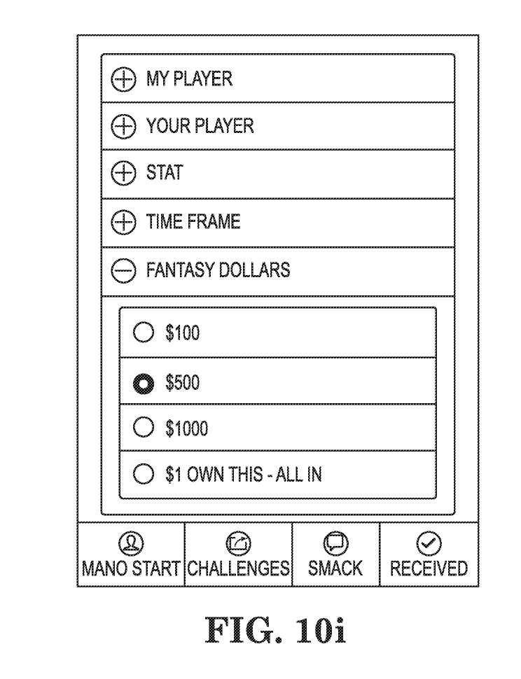

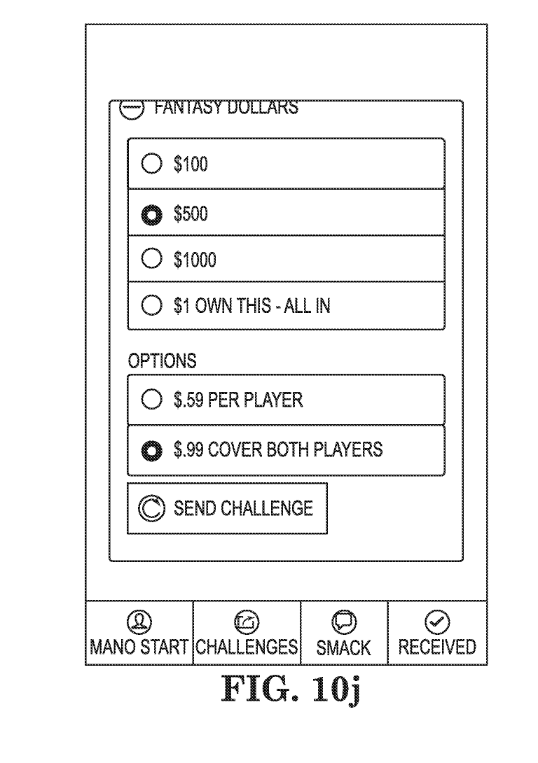

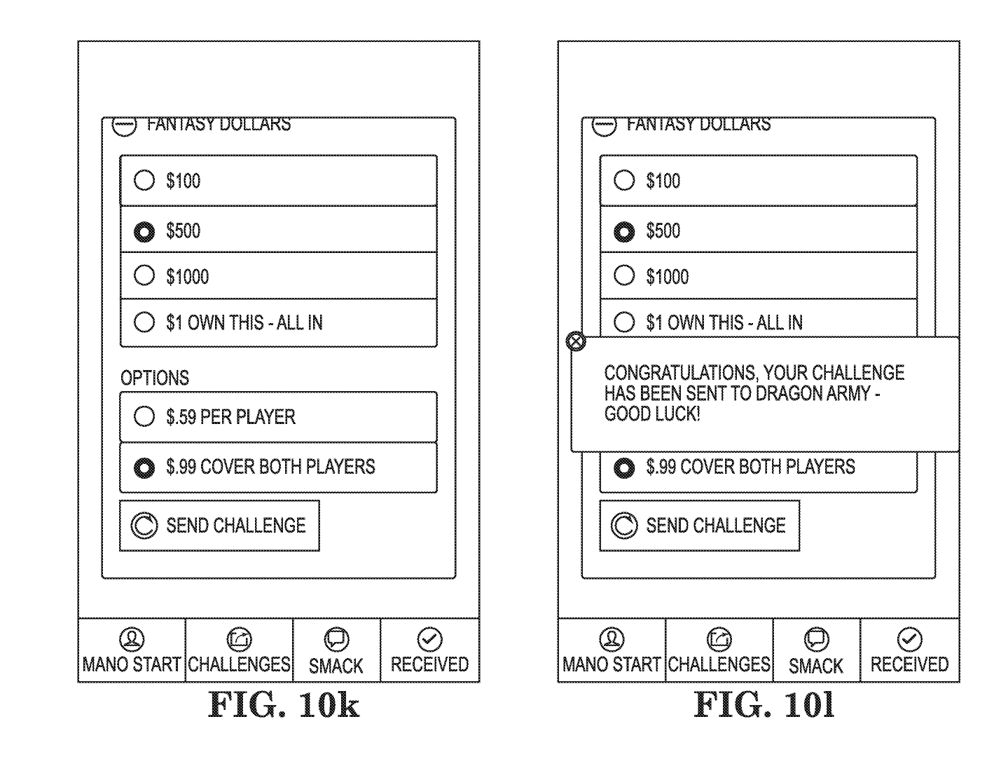

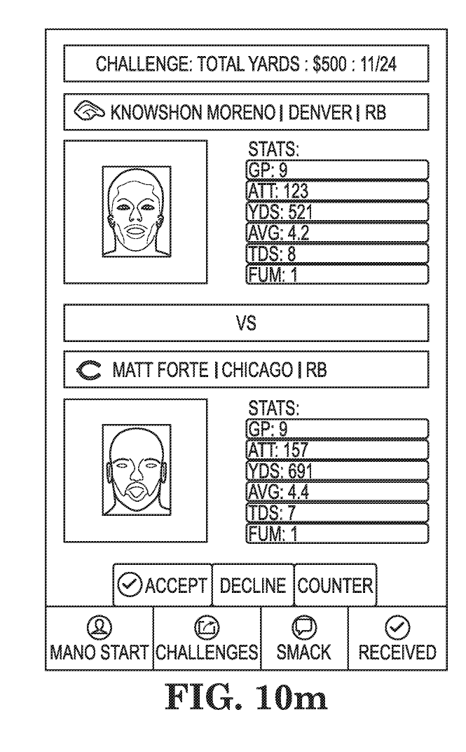

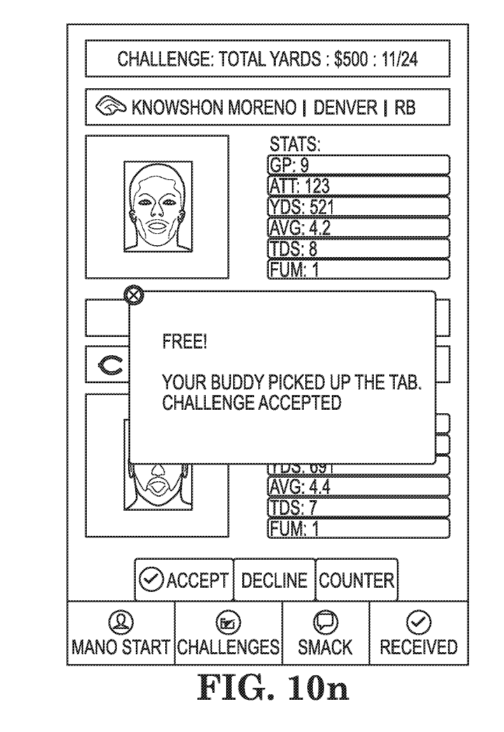

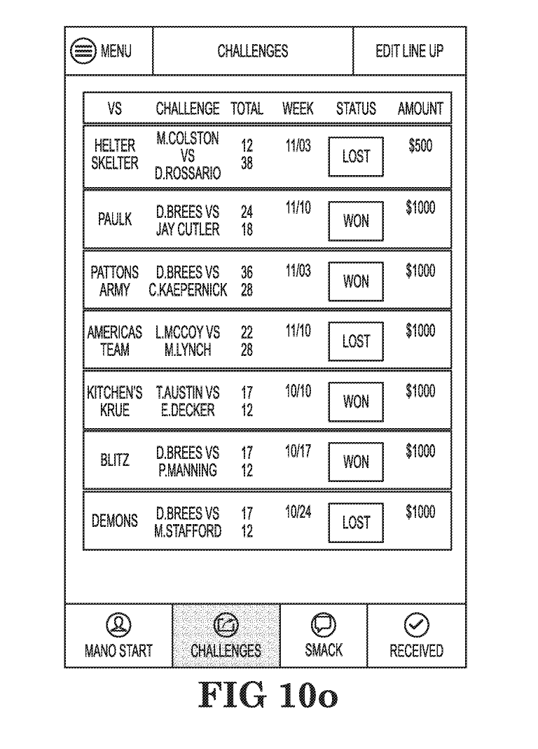

FIGS. 10a and 10b illustrate GUI screens, with greater particularity, the aforementioned one-on-one format. In the illustrations, the league manager has provided for the availability of one-on-one challenges, and a fantasy coach/player may thus select a team against whom the one-on-one challenge will occur, a one-on-one to occur, and whether to start the one-on-one challenge. More specifically, in the GUI screen of FIG. 10c, the team against whom the one-on-one challenge is to occur is selected and in the GUI screen of FIG. 10d, the particular one-on-one challenge desired is selected. FIGS. 10e and 10f illustrate the GUI screen for selection of a real world player for the one-on-one challenge from that fantasy coach's team, and the challenged real world player from the other team, respectively.

FIG. 10g illustrates a particular GUI screen for the player to select a statistic for the one-on-one challenge. FIG. 10h is a GUI screen showing the player selecting the duration of the challenge. It will be well understood to those skilled in the art that the disclosed one-on-one challenge may be for an active in-season fantasy format or for the off-season and/or inactive format, or for combinations thereof, as discussed herein.

FIG. 10i illustrates, by way of example, a GUI screen where the user screen where the player selects the particulars of a challenge. That includes any monies or currency that may be wagered, virtual monies may also be wagered, fantasy game points or bonus points may be wagered, or the like. For example, in the event the challenge is a monetary challenge, a payment selection may be made; in the event a challenge is with regard to fantasy points, a fantasy point bank or bonus bank may be selected. This is illustrated more particularly in the GUI screen of FIG. 10j.

As illustrated in the GUI screens shown in FIGS. 10k and 101, once setup is completed, a challenge may be sent to the challenged fantasy player/coach, and the sending of the challenge may be confirmed to the user player/coach. Of course, once sent to the challenged fantasy player/coach, the challenged player/coach may accept, decline or counter the one-on-one challenge. As such, the challenged fantasy player/coach may be provided with key information regarding a challenge, such as the challenged competitors, key stats of the competitors, wager and amount, dates of the challenge, details of the challenge, smack talk of the challenger, or the like, in order to decide to accept or decline the challenge. The foregoing is illustrated in the GUI screen of FIG. 10m by way of non-limiting example.

FIG. 10n shows a screen indicating that a challenge was accepted, and the previously selected payment criteria may be offered or applied. In this exemplary illustration, the challenger has agreed to provide payment for both parties in the challenge. Of course, upon acceptance of a challenge other payment types may be requested or applied.

As mentioned above, the present disclosure may provide a typical fantasy sports GUI, as is known to those of ordinary skill in the pertinent arts. With regard to a one-on-one challenge, for example, a GUI may be provided as illustrated in the example screen of FIG. 10o. In this illustration, a fantasy sports player/coach can drill down to access a global list of complete, current, or open challenges, such as including opponents, amounts, challenge status, scores, dates, details, and the like. Of course, as is the case with known fantasy sports GUIs, a fantasy sports coach reviewing the list may be enabled to redirect to other information, such as Facebook or Twitter postings, attached emails or documents for a given challenge, or the like. Moreover, a drill down at the screen may allow for a review of open and closed payments, monies in escrow, or the like.

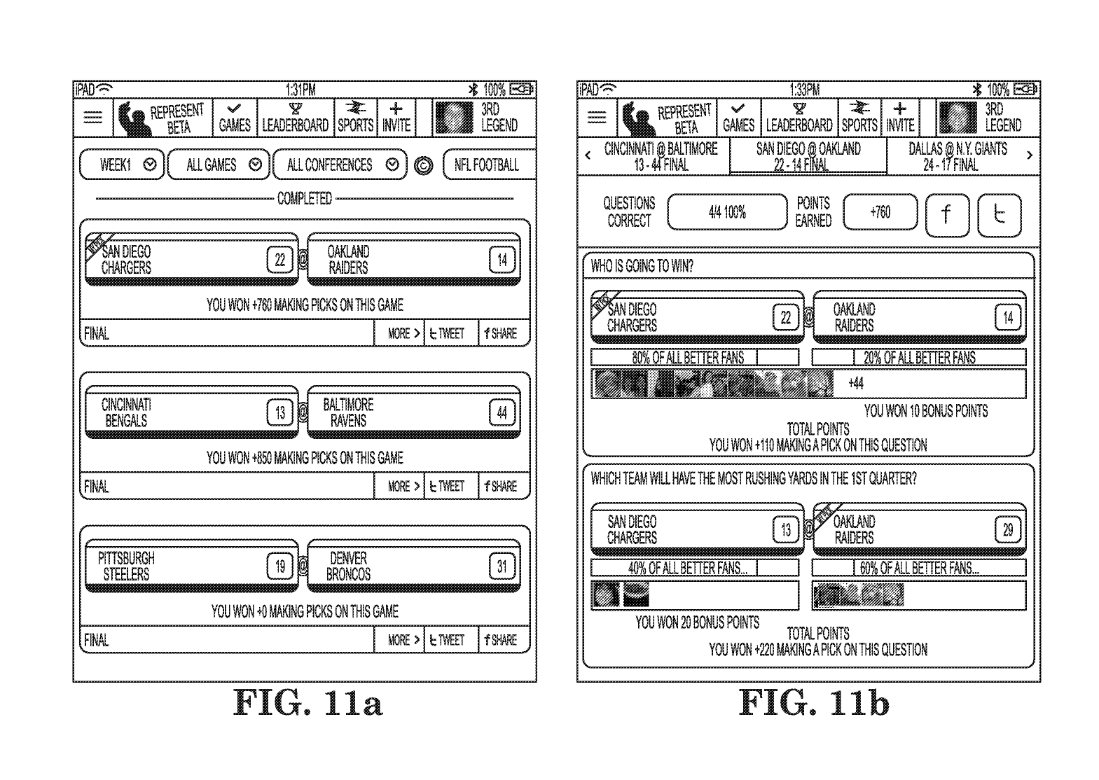

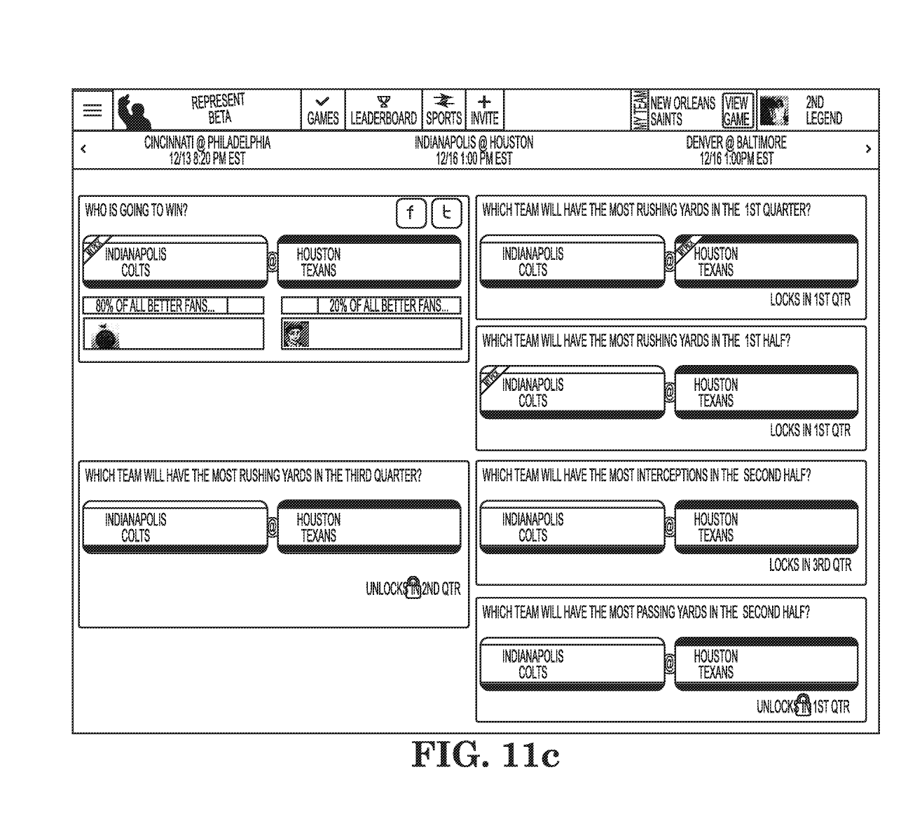

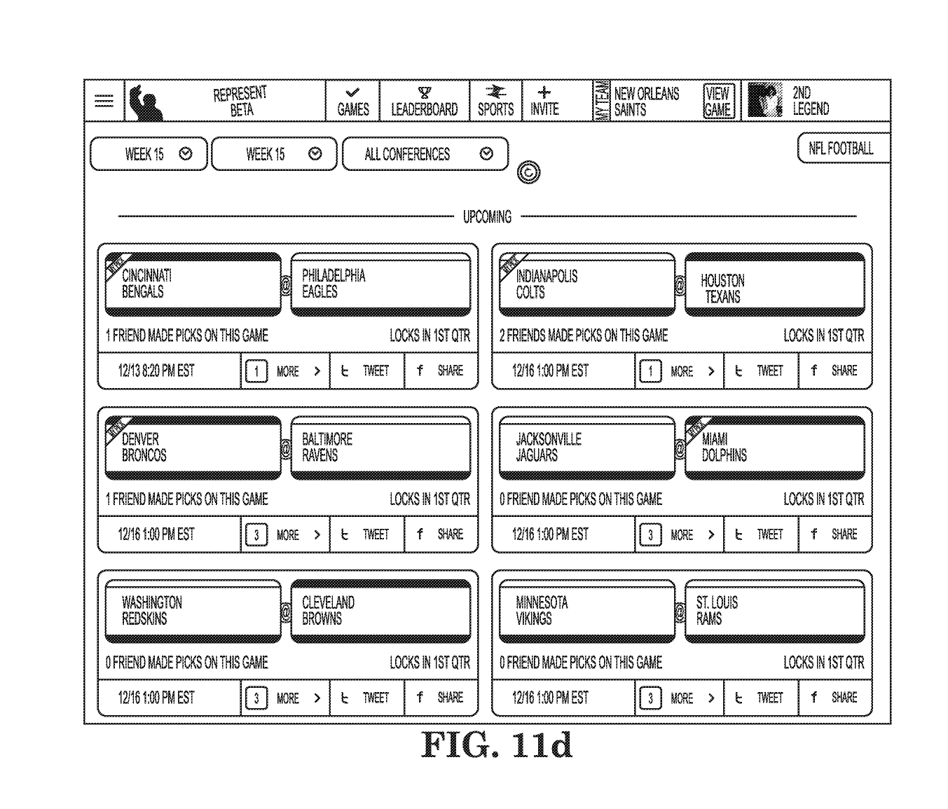

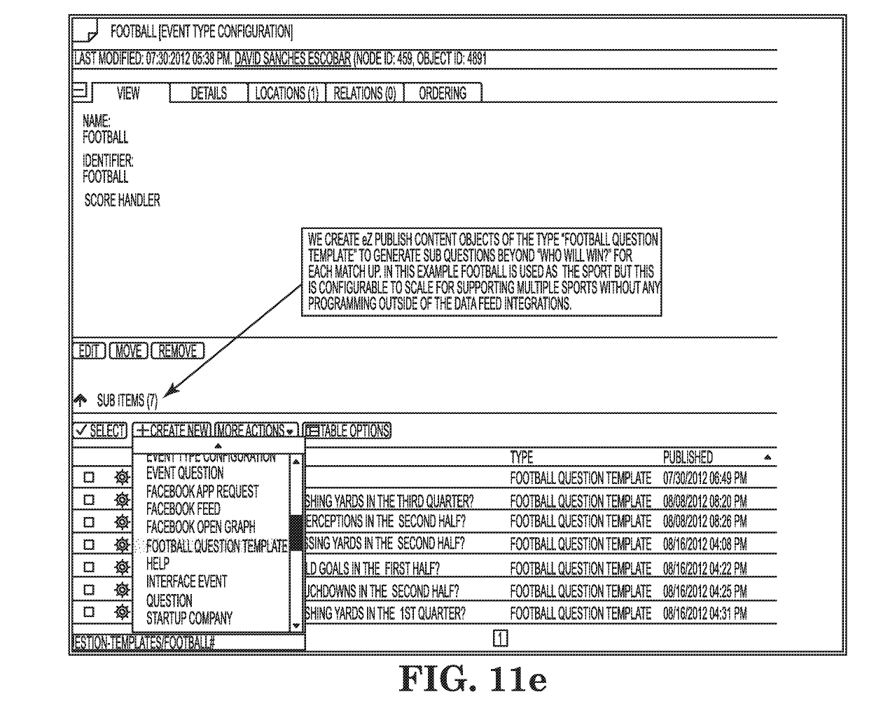

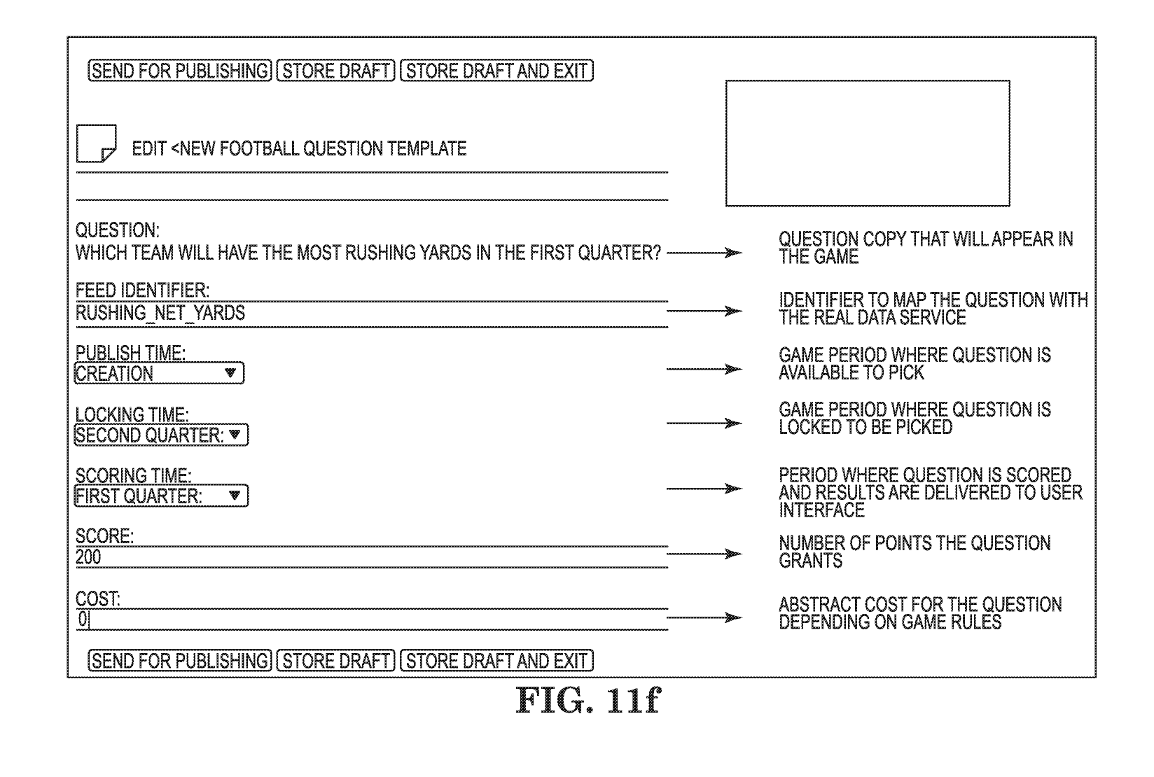

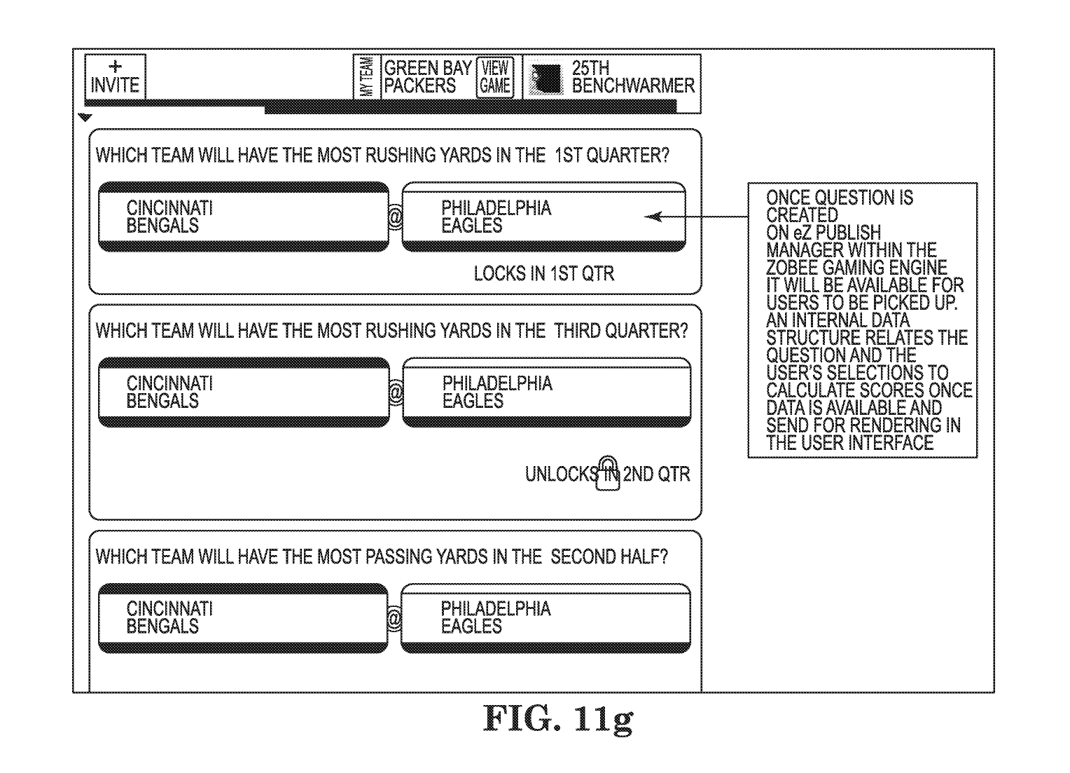

FIGS. 11a and 11b illustrate various additional aspects that may be provided in the instant disclosure by a disclosed GUI. For example, the data tracking of the present invention may allow for a live “pick 'em”, wherein points or monies earned may be tracked in real time, and may be tied to presently active games, randomized previous games, or bell curve data, or the like. Further, the disclosed pick 'em may be related to the one-on-one challenges discussed above, such as wherein players may be enabled to select winners by quarter, statistical winners, and/or the like. Similarly, FIG. 11c illustrates a GUI screen where a fantasy player/coach may view what teams her friends or competitors are picking, such as after making her picks; what percentage of a game, team, statistic, or the like is globally being picked across multiple fantasy sports leagues or the like; available bonuses, points to date, likely points to be won in the near term, or the like; live trivia; live smack talk, and so on.

Upcoming “pick 'em” fantasy games, such as shown in the GUI screen of FIG. 11d, may provide or include sub-competitions/questions that are secondary to the main pick 'em competition. Such sub-competitions may be setup by an administrator, commissioner, or fantasy player/coach in any known manner, such as that shown in the GUI screen examples of FIGS. 11e and 11f, and may be bound to a particular fantasy game or to other exposed “hooks” in the fantasy game engine, by way of non-limiting example. As is the case with fantasy game competitions in the main, sub-competitions may have criteria, preferences, and/or triggers associated therewith, such as not starting until, or ending at, a particular quarter of a football game, as illustrated in the exemplary GUI embodiment of FIG. 11g.

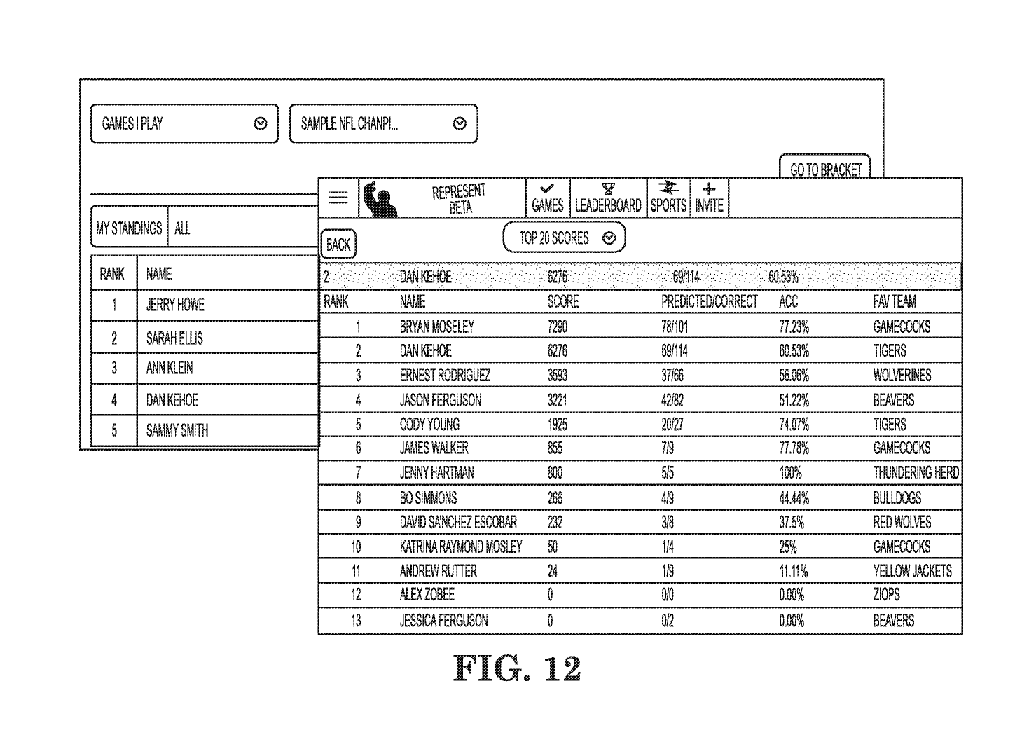

Of course, one or more of the foregoing GUI interfaces, game types, or the like may be coupled or uncoupled, as disclosed. Moreover, any one or more of the game types, interfaces or the like may be made available by any one or more access methods, such as by the web, via one or more apps or applications, via social media, via a smart television, via game console, or the like. As such, FIG. 12 illustrates two GUI screens showing exemplary tracking of standings, leaders, or the like, which may be coupled or decoupled by game, sport, game format, device type, or the like.

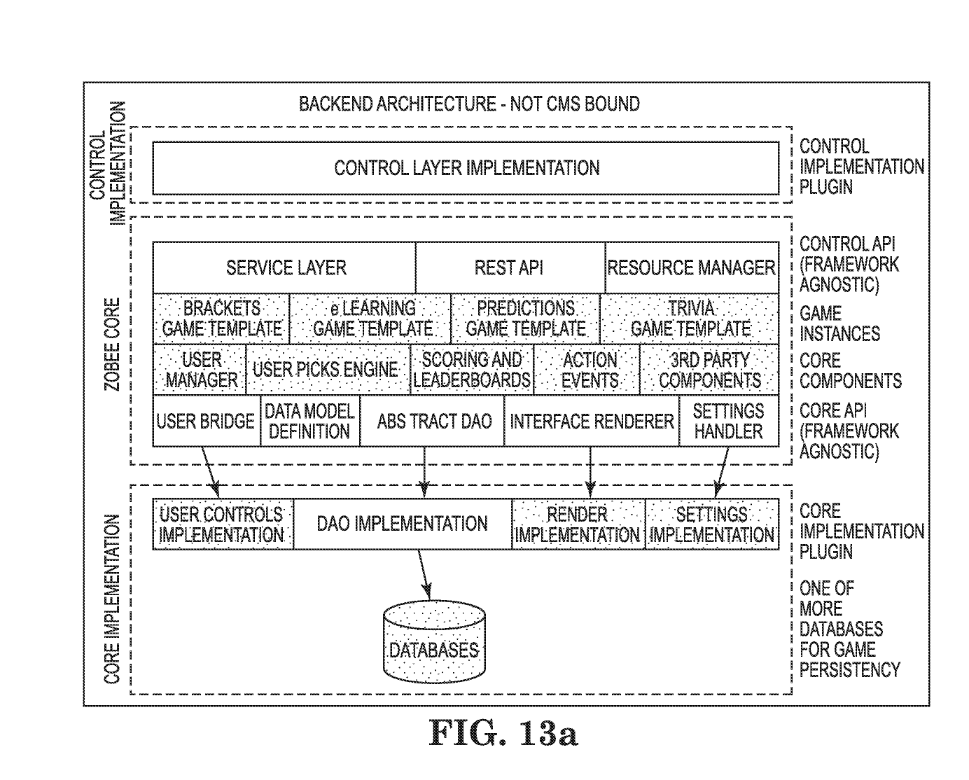

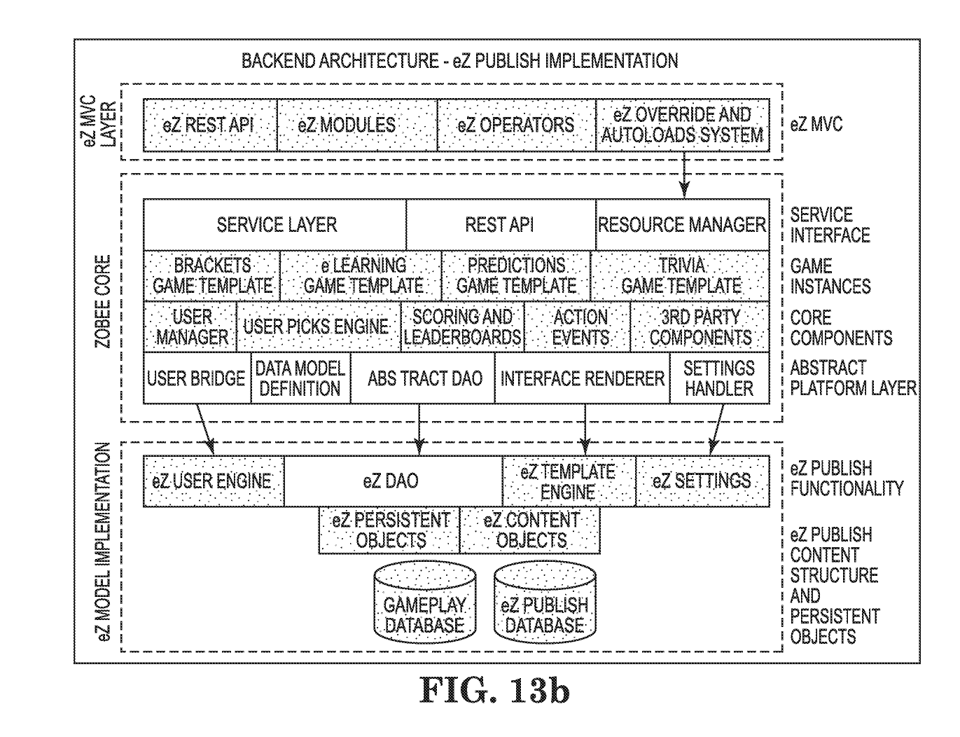

FIG. 13a is an exemplary illustration of a back-end architecture stack for association with the disclosed embodiments. In the disclosed embodiment, one or more databases, such as the bell curve data store discussed herein, may be accessible by one or more plug-ins to a core gaming engine for implementation of the disclosed embodiments. The core engine may include application program interfaces (APIs), such as for creation and implementation of the disclosed applications; core components sitting atop the APIs; various game instances that affect the various games and game types discussed herein; and a control layer for controlling the games discussed herein.

FIG. 13b is an illustrative implementation of an alternative backend architecture stack, including CMS binding, provided for comparison with FIG. 13a.

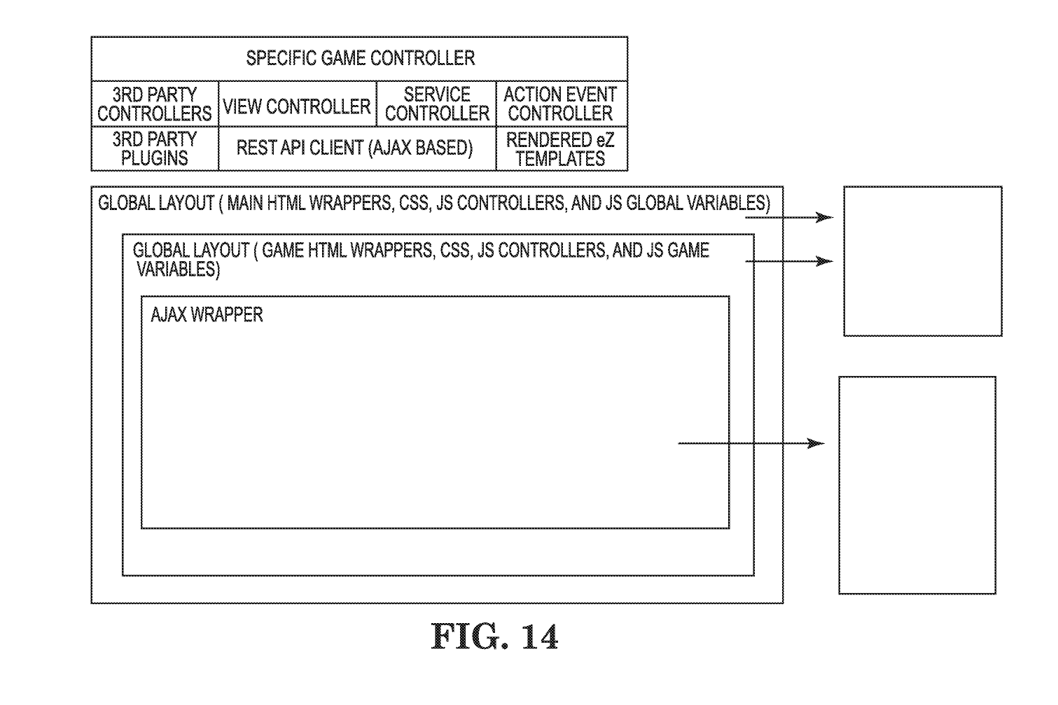

FIG. 14 illustrates an exemplary front end, i.e., user facing, architecture stack, suitable for association with the various embodiments disclosed throughout. As used herein, a stack is defined to include a hierarchical set of software programs or code segments, also referred to as applications, engines, or operating systems, that work together to produce the disclosed results.

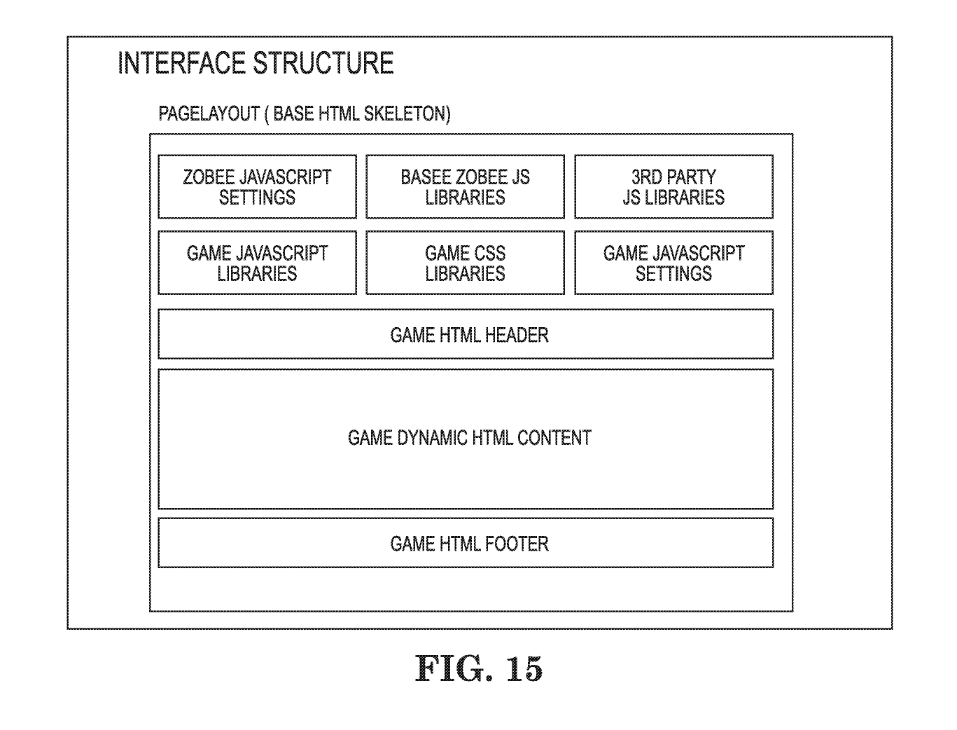

FIG. 15 illustrates an exemplary skeletal layout for the disclosed GUIs, which in this illustration is provided as HTML format, by way of non-limiting example.

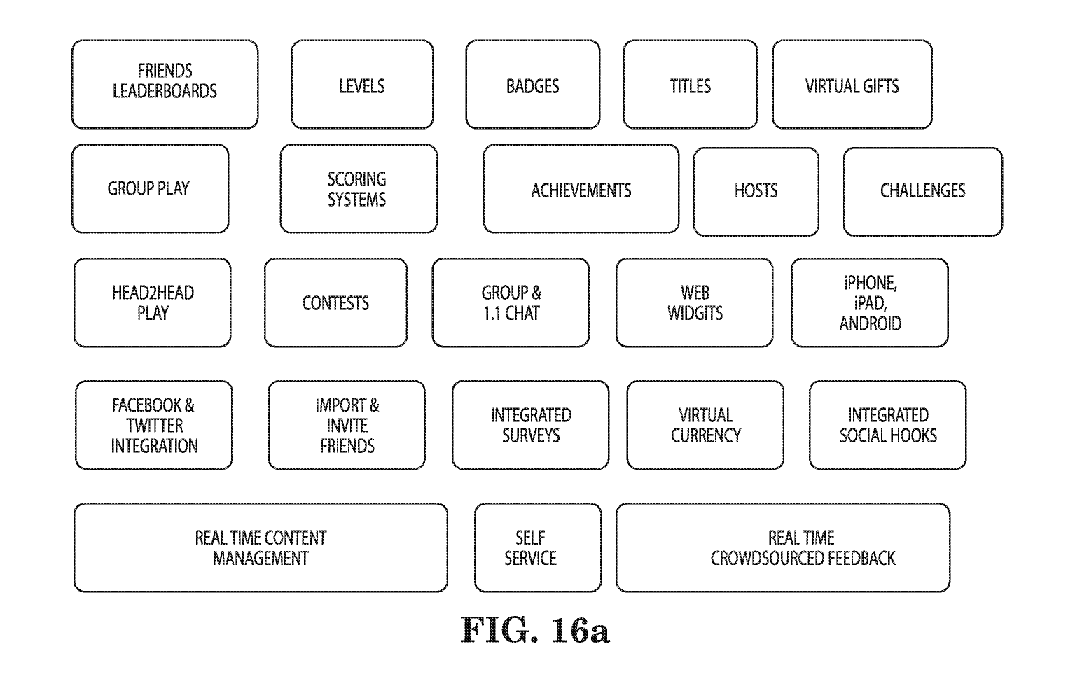

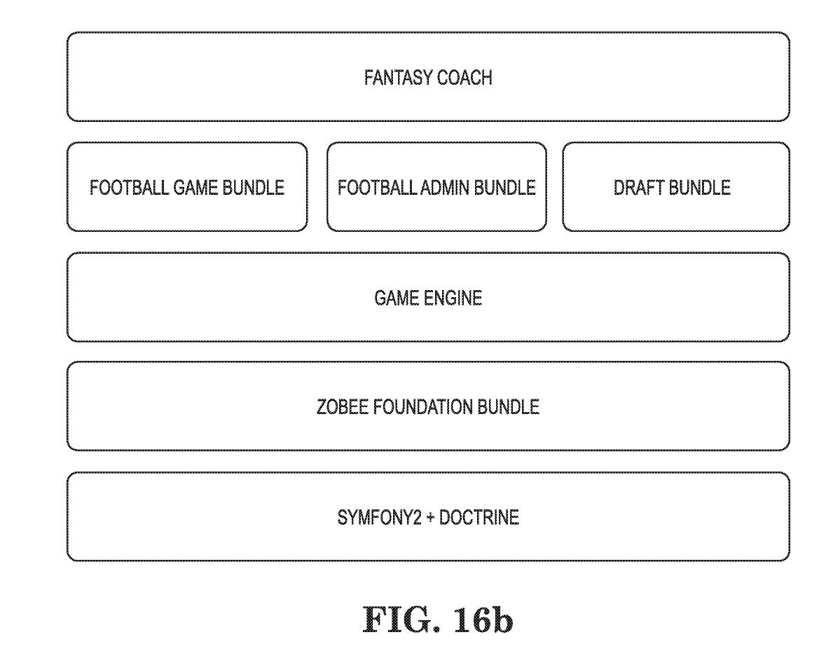

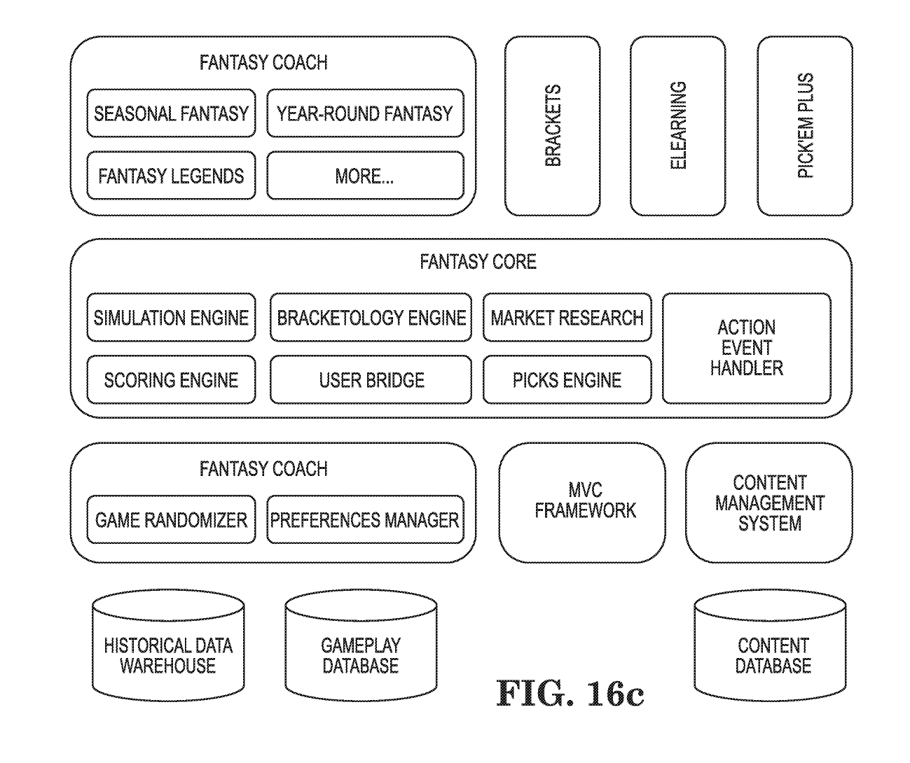

FIGS. 16a and 16b are exemplary illustrations of the software code modules that may be architecturally provided for association with the stack of a particular backend implementation of the various disclosed embodiments.

FIG. 16c is an architectural abstract illustrating the disclosed system elements, including various of those elements discussed hereinabove with respect to FIG. 2. As used herein, software architecture is defined to include the high level structural aspect of the disclosed software systems, engines and methods, the creation of such structural aspects, and the documentation of those structural aspects.

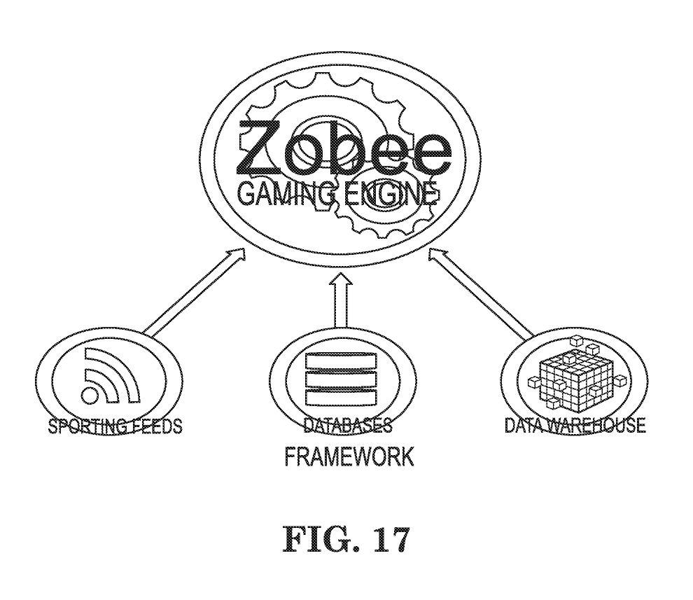

FIG. 17 is an exemplary illustration of a gaming engine provided in accordance with the disclosed embodiments. As shown, the gaming engine may have access to one or more remotely located or third party owned/controlled data warehouses, such as the bell curve data store discussed herein.

Similarly, the gaming engine may have accessible thereto one or more in-house databases, which may be or include modified data obtained from, for example, one or more of the data warehouses.

Additionally, the present gaming engine may have accessible thereto a variety of feeds, such as via networked proprietary or third party communication links, such as real time game data feeds, information regarding teams or athletes or outcomes, or the like.

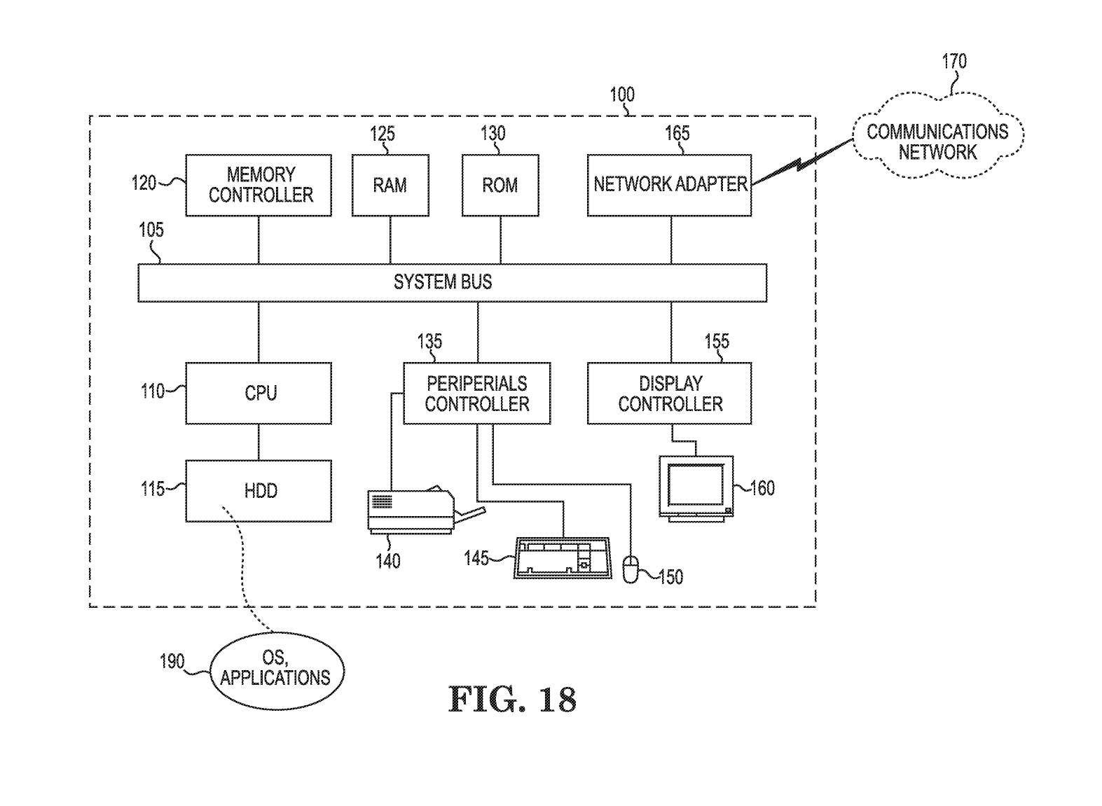

FIG. 18 depicts an exemplary computing system 100 for use in accordance with herein described system and methods. Computing system 100 is capable of executing software code, such as an operating system (OS) and a variety of computing applications 190.

The operation of exemplary computing system 100 is controlled primarily by computer readable instructions, such as instructions stored in a physical computer-readable storage medium, such as hard disk drive (HDD) 115, optical disk (not shown) such as a CD or DVD, solid state drive (not shown) such as a USB “thumb drive,” at a remote data store available via network 170, or the like. Such instructions may be executed within a processor or central processing unit (CPU) 110 to cause computing system 100 to perform various operations. In many known computer servers, workstations, personal computers, and the like, CPU 110 is implemented in an integrated circuit called a processor or microprocessor.

Although exemplary computing system 100 is shown to comprise a single CPU 110, such description is merely illustrative as computing system 100 may comprise a plurality of CPUs 110. Additionally, computing system 100 may exploit the resources of remote CPUs (not shown), for example, through communications network 170 or some other data communications means.

In operation, CPU 110 fetches, decodes, and executes instructions (e.g. code segments) stored on the computer readable storage medium such as HDD 115. Such instructions can be included in software such as an operating system (OS), executable programs associated with the CPU or communicative with the CPU, such as in the aforementioned cameras and/or associated with the providing of the content to the consumer, and the like. Information, such as computer instructions or code and other computer readable data, is transferred between components of computing system 100 via the system's main data-transfer path. The main data transfer path may use a system bus architecture 105, although other computer architectures (not shown) can be used.

System bus 105 can include data lines for sending data, address lines for sending addresses, and control lines for sending interrupts and for operating the system bus. Some busses provide bus arbitration that regulates access to the bus by extension cards, controllers, and CPU 110. Devices that attach to the busses and arbitrate access to the bus are called bus masters. Bus master support also allows multiprocessor configurations of the busses to be created by the addition of bus master adapters containing processors and support chips.

Memory devices coupled to system bus 105 can include random access memory (RAM) 125 and read only memory (ROM) 130. Such memories include circuitry that allows information to be stored and retrieved. ROMs 130 generally contain stored data that cannot be modified. Data stored in RAM 125 can be read or changed by CPU 110 or other hardware devices. Access to RAM 125 and/or ROM 130 may be controlled by memory controller 120. Memory controller 120 may provide an address translation function that translates virtual addresses into physical addresses as instructions are executed. Memory controller 120 may also provide a memory protection function that isolates processes within the system and isolates system processes from user processes. Thus, a program running in user mode can normally access only memory mapped by its own process virtual address space; it cannot access memory within another process' virtual address space unless memory sharing between the processes has been set up.

In addition, computing system 100 may contain peripheral controller 135 responsible for communicating instructions using a peripheral bus from CPU 110 to peripherals, such as printer 140, keyboard 145, and mouse 150. An example of a peripheral bus is the Peripheral Component Interconnect (PCI) bus.

Display 160, which is controlled by display controller 155, can be used to display visual output, such as the live video and/or GUI discussed above, and/or presentation generated by or at the request of computing system 100. Such visual output may include text, graphics, animated graphics, and/or video, for example. Display 160 may be implemented with a CRT-based video display, an LCD-based flat-panel display, gas plasma-based flat-panel display, touch-panel, or the like. Display controller 155 includes electronic components required to generate a video signal that is sent to display 160.

Further, computing system 100 may contain a network adapter 165 which may be used to couple computing system 100 to an external communication network 170, which may include or provide access to the Internet, a cellular or satellite network, or the like. Communications network 170 may provide user access for computing system 100 with means of communicating and transferring software and information electronically. Additionally, communications network 170 may provide for distributed processing, which involves several computers and the sharing of workloads or cooperative efforts in performing a task. It is appreciated that the network connections shown are exemplary and other means of establishing communications links between computing system 100 and remote users may be used.

Exemplary computing system 100 is merely illustrative of a computing environment in which the herein described systems and methods may operate and does not limit the implementation of the herein described systems and methods from computing environments having differing components and configurations. That is, the inventive concepts described herein may be implemented in various computing environments using various components and configurations.

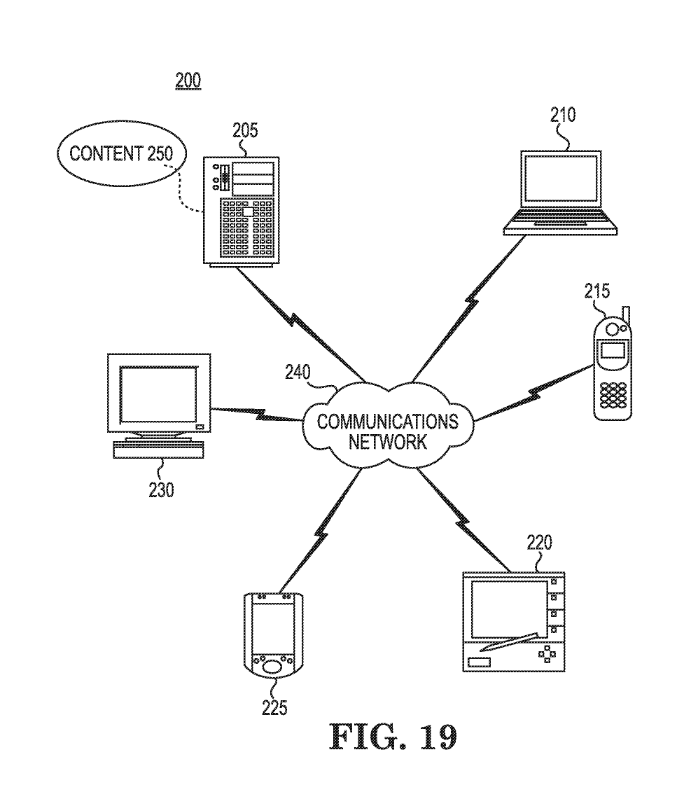

As shown in FIG. 19, computing system 100 can be deployed in networked computing environment 200. In general, the above description for computing system 100 applies to server, client, and peer computers/tablets/smartphones deployed in a networked environment, for example, server 205, laptop computer 210, smartphone 215, smartphone 225 and desktop computer 230. FIG. 19 illustrates an exemplary illustrative networked computing environment 200, with a server in communication with client computing and/or communicating devices via a communications network, in which the herein described apparatus and methods may be employed.

As shown in FIG. 19, server 205 may be interconnected via a communications network 240 (which may include any of, or any combination of, a fixed-wire or wireless LAN, WAN, intranet, extranet, peer-to-peer network, virtual private network, the Internet, or other communications network such as POTS, ISDN, VoIP, PSTN, etc.) with a number of client computing/communication/receiving devices, such as laptop computer 210, wireless mobile telephone 215, tablet computer 220, smartphone 225 and user desktop computer 230. Additional equipment such as televisions, set top boxes, gaming systems, and/or other communication enabled devices (not shown), which are all forms of computing devices, may also be connected to one another in the system through the communications network. Thus, the computing devices forming the back end, remote databases and user equipments for game engine interaction vie the GUI are generally not limited to specific hardware form.

Server 205 can comprise dedicated servers operable to process and communicate data such as digital content 250 (e.g. video clips and/or streams) to and from client devices 210, 215, 220, 225, 230, etc. using any of a number of known protocols, such as hypertext transfer protocol (HTTP), file transfer protocol (FTP), simple object access protocol (SOAP), wireless application protocol (WAP), or the like. Additionally, networked computing environment 200 can utilize various data security protocols such as secured socket layer (SSL), pretty good privacy (PGP), virtual private network (VPN) security, or the like. Each client device or equipment 210, 215, 220, 225, 230, etc. can be equipped with an OS operable to support one or more computing and/or communication applications, such as a web browser (not shown), email (not shown), or the like, to interact with server 205.

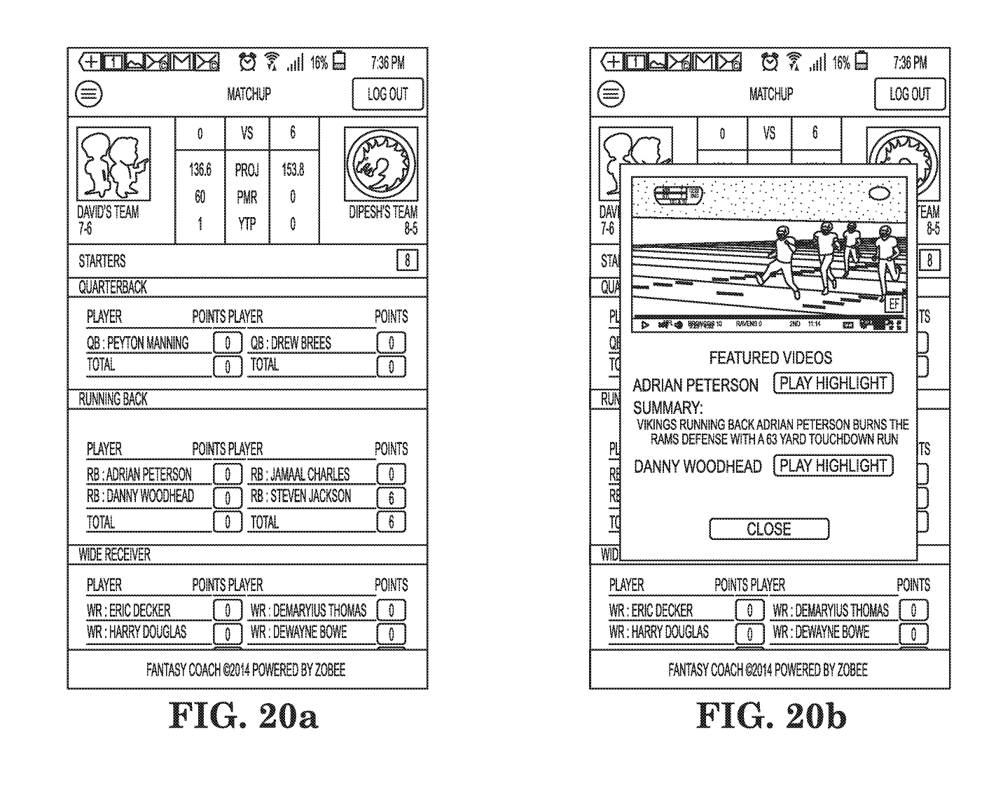

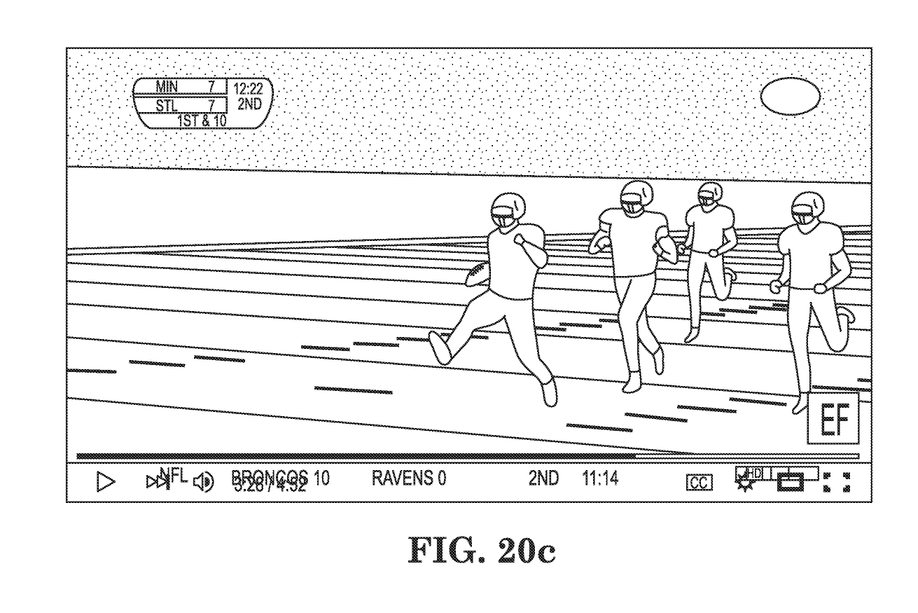

FIGS. 20a and 20b are exemplary illustrations of a GUI for allowing a user to select video highlights for certain players on their roster. Of course the video highlights selection can also be provided for players on competitor's rosters and free agents (not on any roster in a given league).

As shown in FIG. 20a, the user/coach is presented with at least a portion of the list of players on their current roster. Selecting the “featured videos” option opens a video player screen such as shown in FIG. 20b. The user is presented with a description of relevant highlights for the selected player or category of player (here, the user's running backs). An option is provided to select to watch one or more highlights for each player. The user can select individual highlights or can play all at once in a series.

Selecting the “play highlight” option causes a video portion to play within the player window as shown in FIG. 20b. The user can also select the window where the video appears to cause the highlight video to play in full screen mode as shown in FIG. 20c.

The highlight videos can be achieved via hyperlinks to a variety of video sources, including without limitation, television broadcast network websites, video services such as YOUTUBE and via the various sports organizations (e.g. NFL, NHL, MLB, etc.).

Providing the video highlights options to the user can be provided without additional compensation or it can be an additional cost feature. For example, the user may elect to be charged for each highlight played, or they may subscribe to user tier of service that includes video playback as a feature of that tier. A portion of the revenue generated from video highlight viewing activities can be shared with broadcast entities to secure access to copyrighted or otherwise non-publically available video.

In an additional variant, the user can be additionally be provided with the ability to watch video streams of live action sporting events in a similar manner.

The various GUI screens described or illustrated throughout this disclosure can be rendered via software code that is stored in memory coupled to the user's device or the gaming engine. In the former embodiment, the software executed locally on the user's device and sends to the gaming engine over the network the user selection data and received game play data from the gaming engine. In the latter embodiment, the user can interact with a web interface (e.g. HTML or similar) with a web server coupled to, or incorporated into) the gaming engine.

Those of skill in the art will appreciate that the herein described systems and methods may be subject to various modifications and alternative constructions. There is no intention to limit the scope of the invention to the specific constructions described herein. Rather, the herein described systems and methods are intended to cover all modifications, alternative constructions, and equivalents falling within the scope and spirit of the invention and its equivalents.

While the invention has been described in connection with what is presently considered to be the most practical and preferred embodiments, it will be apparent to those of ordinary skill in the art that the invention is not to be limited to the disclosed embodiments. It will be readily apparent to those of ordinary skill in the art that many modifications and equivalent arrangements can be made thereof without departing from the spirit and scope of the present disclosure, such scope to be accorded the broadest interpretation of the appended claims so as to encompass all equivalent structures and products. Moreover, features or aspects of various example embodiments may be mixed and matched (even if such combination is not explicitly described herein) without departing from the scope of the invention.

What is claimed is:

1. A gaming software code architecture suitable for execution by at least one computing processor for providing fantasy sports play, comprising:
a first code segment for accessing, from at least one computing memory store, network accessibly remote from and associated with the at least one processor, a plurality of outcome data indicative of player performance of real world sports play corresponding to the fantasy sports play, wherein the plurality of outcome data accessed at least partially comprises historical player performance data;
a second code segment for transforming the plurality of outcome data to fantasy sports play data agnostically to an active or inactive status of the real world sports play; and
a third code segment for determining an outcome of the fantasy sports play at least partially in accordance with the fantasy sports play data.

2. The gaming software code architecture of claim 1, further comprising a fourth code segment for controlling said code for transforming in accordance with a plurality of indicated preferences for the fantasy sports play.

3. The gaming software code architecture of claim 1, further comprising a fifth code segment for populating players of the real world sports play onto teams for the fantasy sports play.

4. The gaming software code architecture of claim 3, wherein the populated players at least partially comprise inactive players.

5. The gaming code software architecture of claim 4, wherein the inactive players at least partially comprise retired players.

6. The gaming software code architecture of claim 3, further comprising a sixth code segment for locally providing networked content regarding the populated players.

7. The gaming software code architecture of claim 6, wherein the networked content comprises highlight videos.

8. The gaming software code architecture of claim 1, wherein the plurality of outcome data at least partially comprises real-time generated performance data.

9. The gaming software code architecture of claim 1, wherein the plurality of outcome data comprises a respective bell curve for each real world player.

10. The gaming software code architecture of claim 9, wherein the bell curve is respective to a single season of the real world sports play.

11. The gaming software code architecture of claim 10, wherein the bell curve comprises divisions of single games of a single season of the real world sports play.

12. The gaming software code architecture of claim 9, wherein the first code segment includes code for randomizing the plurality of outcome data.

13. The gaming software code architecture of claim 10, wherein the bell curve is selected from a randomized data set subject to at least one user preference.

14. The gaming software code architecture of claim 9, wherein the first code segment includes code for quasi-randomly accessing the plurality of outcome data.

15. The gaming software code architecture of claim 1, wherein the second code segment includes code for transforming the fantasy sports play data into a simulated real world sports play data set.

16. The gaming software code architecture of claim 1, wherein the fantasy sports play comprises play pace substantially correspondent to real time play of the real world sports play.

17. The gaming software code architecture of claim 1, further comprising a fourth code segment for insuring statistical significance of the plurality of outcome data accessed by said code for accessing.

18. A fantasy gaming system, comprising:
a database containing inactive sports player performance data;
a gaming computing engine located remote from the database and coupled to the database by a network, the gaming computing engine configured to:
access a set of inactive sports player performance data according to a set of parameters from the database;
transform the set of inactive sports player performance data into a simulated fantasy sports play data set; and
determining an outcome of a fantasy sports game based upon the simulated fantasy sports play data set.

19. The fantasy gaming system of claim 18, wherein the gaming computing engine is further configured to combine a set of active player performance data with the simulated fantasy sports play data set, and the step of determining an outcome is based upon the combined active and simulated fantasy sports pay data set.

20. The fantasy gaming system of claim 18, wherein the gaming engine is further configured to deliver a video clip to a user equipment, wherein the video clip corresponds to the simulated fantasy sports play data set.
